(19) United States
(12) Patent Application Publication
(10) Pub. No.: US 2024/0290986 A1
(43) Pub. Date: Aug. 29, 2024

(54) SELF-STANDING ELECTRODES AND METHODS AND APPARATUS FOR MAKING THE SAME

(71) Applicant: Honda Motor Co., Ltd., Tokyo (JP)

(72) Inventor: Avetik HARUTYUNYAN, Santa Clara, CA (US)

(21) Appl. No.: 18/114,011

(22) Filed: Feb. 24, 2023

(51) Int. Cl. H01M 4/62; C01B 32/16; H01M 4/04; H01M 4/131; H01M 4/1391

(52) U.S. Cl. CPC H01M 4/626; C01B 32/16; H01M 4/0419; H01M 4/131; H01M 4/1391; C01B 2202/08; C01B 2202/22

(57) ABSTRACT

Aspects of the present disclosure generally relate to battery technology, and more specifically relate to self-standing electrodes and to methods and apparatus for making the same. In an embodiment, a self-standing electrode is provided. The self-standing electrode includes nanotubes, electrode active material, and conductive material. In another embodiment, a method of forming a self-standing electrode is provided. The method includes aerosolizing or fluidizing electrode active material and conductive material. The method further includes depositing nanotubes, the aerosolized or fluidized electrode active material, and the aerosolized or fluidized conductive material on a porous substrate to form a self-standing electrode, the self-standing electrode comprising the nanotubes, the electrode active material, and the conductive material.

### FIELD

Aspects of the present disclosure generally relate to battery technology, and more specifically relate to self-standing electrodes and to methods and apparatus for making the same.

### BACKGROUND

Carbon nanotubes (CNTs) as additives in various matrices has become one of the most intensively studied areas for applications, owing to their excellent electrical and mechanical properties and high aspect ratio, which is critical for composite materials. Among various applications, the exploitation of CNTs, as well as single walled carbon nanotubes (SWNTs) as an additive material for performance enhancement of battery electrodes is promising. Various methods, including continuous production methods, of forming CNTs are known. In such a method, carbon nanotube supported self-standing electrodes for Li-ion batteries can be formed by co-depositing CNTs and electrode active material on a moving porous substrate. The method utilizes direct deposition of as-grown CNTs from a reactor and an aerosolized active material from a corresponding aerosolizing chamber onto a porous substrate that is attached to a roll-to-roll system. The resulting deposited layer contains CNTs in the active material. After removing the deposited layer from the substrate, the layer can be pressed, casted, and attached to conducting tabs to form a self-standing electrode. Because this electrode lacks a current collector and binder, the electrode has about 40% higher specific energy density compared to conventional electrodes. However, the electrical conductivity of the self-standing electrode is low relative to those having copper (Cu) or aluminum (Al) current collector foils. The decreased electrical conductivity can limit the usage of such self-standing electrodes in batteries for fast-charging applications or other applications.

There is a need for new and improved self-standing electrodes and methods and apparatus for making such self-standing electrodes.

### SUMMARY

Aspects of the present disclosure generally relate to battery technology, and more specifically relate to self-standing electrodes and to methods and apparatus for making the same.

In an embodiment, a self-standing electrode is provided. The self-standing electrode includes nanotubes, electrode active material, and conductive material, wherein the conductive material is dispersed, embedded, or otherwise incorporated in the nanotubes, the electrode active material, or both.

In another embodiment, a battery is provided. The battery includes a self-standing electrode described herein.

In another embodiment, an article is provided. The article includes a device and a battery, the battery comprising a self-standing electrode described herein.

In another embodiment, a method of forming a self-standing electrode is provided. The method includes aerosolizing or fluidizing electrode active material and conductive material. The method further includes depositing nanotubes, the aerosolized or fluidized electrode active material, and the aerosolized or fluidized conductive material on a porous substrate to form a self-standing electrode, the self-standing electrode comprising the nanotubes, the electrode active material and the conductive material.

In another embodiment, a method of forming a self-standing electrode is provided. The method includes aerosolizing electrode active material and conductive material; directing nanotubes, the aerosolized electrode active material, and the aerosolized conductive material to an outlet; and positioning a movable porous substrate under the outlet material. The method further includes depositing nanotubes, the aerosolized electrode active material, and the aerosolized conductive material on a porous substrate to form a self-standing electrode, the self-standing electrode comprising the nanotubes, the electrode active material and the conductive material, the conductive material of the self-standing electrode being dispersed, embedded, or otherwise incorporated in the nanotubes of the self-standing electrode, the electrode active material of the self-standing electrode, or both.

In another embodiment, a method of forming a self-standing electrode is provided. The method includes introducing at least one suspension or dispersion to a pressure-controlled system, the pressure-controlled system comprising a container and an element having a porous material disposed therein, the porous material disposed above the container, wherein: each suspension or dispersion of the at least one suspension or dispersion comprises one or more of nanotubes, electrode active material, or conductive material; and the conductive material of the at least one suspension or dispersion is in the form of, or derived from, a powder, a particle, or combinations thereof. The method further includes applying a pressure differential across the porous material to draw the at least one suspension or dispersion from the element, through the porous material, and to the container to form a filtrate disposed within the container and a retentate disposed above the porous material, the retentate comprising the self-standing electrode, the self-standing electrode comprising the nanotubes, the electrode active material, and the conductive material.

In another embodiment, a method of forming a self-standing electrode is provided. introducing one or more suspensions or dispersions to a pressure-controlled system, the pressure-controlled system comprising a container and an element having a porous material disposed therein, the porous material disposed above the container, a conductive material disposed above the porous material, each of the one or more suspensions or dispersions comprising at least one of nanotubes or electrode active material. The method further includes applying a pressure differential across the porous material to draw the suspension or dispersion from the element, through the porous material, and to the container to form a filtrate disposed within the container and a retentate disposed above the porous material, the retentate comprising the self-standing electrode, the self-standing electrode comprising the nanotubes, the electrode active material, and the conductive material.

In another embodiment, an apparatus for forming a self-standing electrode is provided. The apparatus includes a nanotube synthesis reactor for forming nanotubes, a first aerosolizing chamber configured to aerosolize an electrode active material into an aerosolized electrode active material, and a second aerosolizing chamber configured to aerosolize a conductive material into an aerosolized conductive material. The apparatus further includes a collection chamber fluidly coupled to the nanotube synthesis reactor, the first aerosolizing chamber, and the second aerosolizing chamber, wherein: the collection chamber has a surface configured to collect the nanotubes, the electrode active material, and the conductive material; and the collection chamber is further configured to remove aerosolizing gas so as to form the self-standing electrode comprising the nanotubes, the electrode active material, and the conductive material.

In another embodiment, an apparatus for forming a self-standing electrode is provided. The apparatus includes a porous material defining a retentate side and a filtrate side, the porous material being porous to a liquid medium, the porous material being substantially impervious or impervious to a composite of nanotubes, an electrode active material, and a conductive material. The apparatus further includes a container on the filtrate side of the porous material, a pressure source coupled to the container, and an element coupled to the container, at least a portion of the element on the filtrate side of the porous material.

### BRIEF DESCRIPTION OF THE DRAWINGS

So that the manner in which the above recited features of the present disclosure can be understood in detail, a more particular description of the disclosure, briefly summarized above, may be had by reference to aspects, some of which are illustrated in the appended drawings. It is to be noted, however, that the appended drawings illustrate only exemplary aspects and are therefore not to be considered limiting of its scope, for the disclosure may admit to other equally effective aspects.

FIG. 1A is a flowchart showing selected operations of a method of making a self-standing electrode according to at least one aspect of the present disclosure.

FIG. 1B is a flow diagram showing an example self-standing electrode made using one or more processes and/or apparatus described herein followed by removal from a substrate according to at least one aspect of the present disclosure.

FIG. 2 is a flow diagram illustrating an example apparatus for making a self-standing electrode according to at least one aspect of the present disclosure.

FIG. 3 is a schematic view illustrating a vessel according to at least one aspect of the present disclosure.

FIG. 4A is a flow diagram illustrating an exemplary apparatus for making a self-standing electrode according to at least one aspect of the present disclosure.

FIG. 4B is a flow diagram illustrating an exemplary apparatus for making a self-standing electrode according to at least one aspect of the present disclosure.

FIG. 5A is a schematic view of an apparatus for making a self-standing electrode according to at least one aspect of the present disclosure.

FIG. 5B is a schematic view of an apparatus for making a self-standing electrode according to at least one aspect of the present disclosure.

FIG. 6 is a schematic view of an apparatus for making a substrate movable according to at least one aspect of the present disclosure.

FIG. 7A is a schematic view of an example apparatus for making a self-standing electrode according to at least one aspect of the present disclosure.

FIG. 7B is a flowchart showing selected operations of a method of making a self-standing electrode according to at least one aspect of the present disclosure.

FIG. 7C is a flowchart showing selected operations of a method of making a self-standing electrode according to at least one aspect of the present disclosure.

FIG. 8A is an illustration of example textile that can be included in example current collectors according to at least one aspect of the present disclosure.

FIG. 8B shows example weaving configurations that can be used for textiles described herein according to at least one aspect of the present disclosure.

FIG. 9 shows example structures for the conductive metal of self-standing electrodes described herein according to at least one aspect of the present disclosure.

FIG. 10A is an exploded perspective view of a conventional lithium-ion battery.

FIG. 10B is an exploded perspective view of an example lithium-ion battery according to at least one aspect of the present disclosure.

### DETAILED DESCRIPTION

Aspects of the present disclosure generally relate to battery technology, and more specifically relate to self-standing electrodes and to methods and apparatus for making the same. The inventor has discovered new and improved self-standing electrodes that can have an improved balance of, for example, energy density and electrical conductivity relative to conventional electrodes. Aspects of the self-standing electrodes include a mixture of carbon nanotubes (CNTs), an electrode active material, and a conductive metal (e.g., Cu and/or Al). In certain aspects, the conductive metal (or conductive material) of the self-standing electrode can be in the form of, for example, powder, particles, mesh, wire, strips, foils, sponge, foam, or other suitable structures, or combinations thereof. The conductive metal of the self-standing electrode can be embedded, dispersed, or otherwise incorporated in the electrode active material of the self-standing electrode, the nanotubes of the self-standing electrode, or both. Additionally, or alternatively, conductive metal can be in a layer that is separate from the nanotubes and/or the electrode active material. Although the inclusion of the conductive metal in the self-standing electrode can increase the weight of the electrode (and can reduce the energy density of the electrode) relative to conventional electrodes that are free of current collectors, self-standing electrodes described herein have significantly higher electrical conductivity relative to conventional electrodes that are free of current collectors. Further, relative to conventional electrodes having current collectors (e.g., in the form of Cu or Al foils), self-standing electrodes of the present disclosure have improved energy density.

Some self-standing electrodes that are free of binder and current collector material (as described in, e.g., U.S. patent application Ser. No. 15/665,171) can have decreased electrical conductivity due to the lack of current collector foil. The decreased electrical conductivity can be a drawback when fast-charging applications are desired. As described herein, such issues can be overcome embedding, dispersing, or otherwise incorporating conductive metal (or conductive material) in the electrode active material, the nanotubes, or both. The embedded, dispersed, or otherwise incorporated conductive material can be in the form of, for example, powder, particles, mesh, wire, strips, foils, sponge, foam, or other suitable structures, or combinations thereof. The resulting self-standing electrodes display, for example, improved electrical conductivity.

Carbon nanotubes (CNTs) as additives in various matrices has become one of the most intensively studied areas for applications, owing to their excellent electrical and mechanical properties and high aspect ratio, which is critical for composite materials. Among various applications, the exploitation of CNTs, as well as single walled carbon nanotubes (SWNTs) as an additive material for performance enhancement of battery electrodes is promising. Various methods, including continuous production methods, of forming CNTs are known. In such a method, carbon nanotube supported self-standing electrodes for Li-ion batteries can be formed by co-depositing CNTs and electrode active material on a moving porous substrate. The method utilizes direct deposition of as-grown CNTs from a reactor and an aerosolized active material from a corresponding aerosolizing chamber onto a porous substrate that is attached to a roll-to-roll system. The resulting deposited layer contains CNTs in the active material. After removing the deposited layer from the substrate, the layer can be pressed, casted, and attached to conducting tabs to form a self-standing electrode. Because this self-standing electrode lacks a current collector and binder, the electrode has about 40% higher specific energy density compared to conventional electrodes. However, the electrical conductivity of the self-standing electrode is low relative to those having copper (Cu) or aluminum (Al) current collector foils. The decreased electrical conductivity can limit its usage in batteries.

As used herein, the term “electrode” refers to an electrical conductor where ions and electrons are exchanged with an electrolyte and an outer circuit. “Positive electrode” and “cathode” are used interchangeably in the present description and refer to the electrode having the higher electrode potential in an electrochemical cell (i.e., higher than the negative electrode). “Negative electrode” and “anode” are used interchangeably in the present description and refer to the electrode having the lower electrode potential in an electrochemical cell (i.e., lower than the positive electrode). Cathodic reduction refers to a gain of electron(s) of a chemical species, and anodic oxidation refers to the loss of electron(s) of a chemical species.

The terms “conductive metal,” “conductive material,” and “conductive metal alloy” are used interchangeably unless specified to the contrary or the context clearly indicates otherwise. Accordingly, use of the terms “conductive metal,” “conductive material,” and “conductive metal alloy” is intended to include the other terms unless specified to the contrary or the context clearly indicates otherwise.

As described below, the inventor has found that depending on the desired structure of the conductive metal (for example, Cu or Al) in the self-standing electrode, the apparatus for making the self-standing electrode can be different. For example, when the structure of the conductive metal in the self-standing electrode is in the form of, e.g., a mesh, a wire, a strip, a foil, a sponge, a foam, or other suitable structures, or combinations thereof, the apparatus can include two chambers (for example, two aerosolizing chambers) that are coupled to a vessel such as a collection chamber, or a mixer. Here, nanotubes can be fed from one chamber to the vessel, while the electrode active material can be fed from the other chamber to the vessel. As another example, when the structure of the conductive metal in the self-standing electrode is in the form of, for example, a powder, the apparatus can include three chambers (for example, three aerosolizing chambers) coupled to a vessel such as a collection chamber or a mixer. Here, nanotubes can be fed from the first chamber to the vessel, electrode active material can be fed from the second chamber to the vessel, and conductive metal (in the form of, for example, a powder) can be fed from the third chamber to the vessel.

As opposed to conventional methods and apparatus for forming self-standing electrodes, apparatus described herein can include an aerosolization chamber for the conductive metal (particles, powders, similar structures, combinations thereof) and methods described herein can include aerosolization of the conductive metal separate from the other components. Alternatively, and in some aspects, when the self-standing electrode includes conductive metal in the form of mesh, wire, strips, foils, sponge, foam, similar structures, or combinations thereof, apparatus and methods described herein can include a substrate having the conductive metal positioned thereon prior to deposition of the nanotubes and electrode active material. These and other embodiments are described below.

Fluidizing (e.g., aerosolizing or suspending/dispersing) the components that make up the self-standing electrode depends on, for example, the size, shape, and density of the components such as the electrode active material and the conductive material. Oftentimes, the conductive material (for example, Cu or Al) has a density that is about twice the density of the electrode active material. Given this difference in density, it is very challenging for conventional technologies to make a homogeneous self-standing electrode as they use a single aerosolization chamber for both the conductive material and the electrode active material. Embodiments described herein overcome this issue.

In some aspects, methods, apparatus, and other aspects described herein can take advantage of the electrical conductivity percolation point of a conductive material (e.g., conductive metal) in order to, for example, improve the electrical conductivity of the resulting self-standing electrode. Here, the inventor has found that the conductivity of the self-standing electrode can be improved by adding low amounts of metal additives (conductive material) into the self-standing electrode while at the same time achieving the highest possible electrical conductivity value. In other words, the concentration of the conductive material added (e.g., conductive metal) can be closer to the electrical conductivity percolation threshold (or percolation point) that is the critical concentration of the conductive material where the electrical conductivity of the self-standing electrode abruptly increases as high conductive pathways are formed. Carbon nanotubes can also enhance the conductivity of the electrode, but it may not provide enough enhancement due to the intrinsic properties of the carbon nanotube network (for example, tube/tube contact electrical resistance that is very high). Metal based additives (e.g., Cu or Al) can further increase the conductivity of self-standing electrode.

The electrical conductivity percolation point of an additive is the point where a certain amount (or percent) of additive causes a large (or abrupt) increase in the electrical conductivity. When the electrical conductivity percolation point is reached, the electrical conductivity measured increases only slowly or levels off even with further increases in additive loading.

The electrical conductivity percolation point can depend on the shape of the conductive material and thereby the aspect ratio of the conductive material. The aspect ratio is the ratio of a material's length “L” to its thickness or diameter “d”. For example, in the case of spherical particles (aspect ratio is 1), about 40-50 wt % of an additive (e.g., carbon) can be used to achieve an abrupt increase of the electrical conductivity, while only about 0.001 wt % for rod-shaped carbon naonotubes (aspect ratio of about 100,000) can be used to achieve an abrupt increase of the electrical conductivity. Similarly, for conductive metal (e.g., Al, Cu) powder additives, it can be desirable to utilize a rod-shaped conductive material with an aspect ratio greater than 1. Here, minimum amounts of the rod-shaped conductive material can provide the desired increase in electrical conductivity.

The electrical conductivity percolation point can be determined by a series of electrical conductance measurements of the corresponding self-standing electrode with varied concentrations of the additives (e.g., the conductive material, the electrode active material, and/or nanotubes). The minimum value of the additive concentration that provides the highest electrical conductance value is the electrical conductivity percolation point. The electrical conductivity percolation point is determined as described in the Examples Section.

Embodiments described herein can include determining an amount of conductive material in the self-standing electrode formed by utilizing an electrical conductivity percolation point of the conductive material. The electrical conductivity percolation point can also be utilized to determine the amount of carbon nanotubes and/or the amount of electrode active material to be added to form the self-standing electrode.

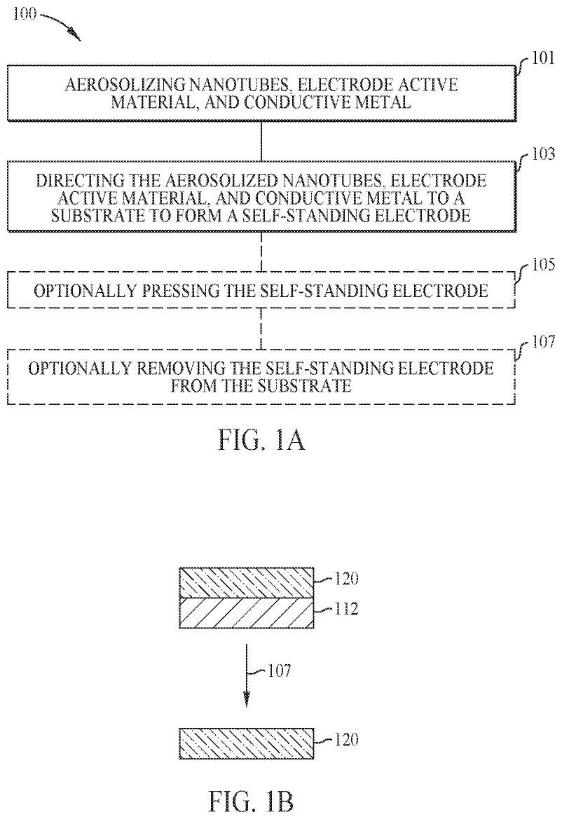

Aspects described herein generally relate to methods of making self-standing electrodes for, e.g., Li-ion batteries. FIG. 1A is a flowchart showing selected operations of a method 100 of making a self-standing electrode according to at least one aspect of the present disclosure. Method 100 is an illustrative, but non-limiting, method. FIG. 1B is a flow diagram showing an example of a self-standing electrode 120 that can be made using one or more processes and/or apparatus described herein followed by removal from a substrate 112 according to at least one aspect of the present disclosure. The flow diagram of FIG. 1B is non-limiting.

Method 100 includes fluidizing or aerosolizing nanotubes, electrode active material, and conductive metal at operation 101. The conductive metal can be copper (Cu) and aluminum (Al), for anode and cathode electrodes, respectively. The amount of a component (a conductive metal, nanotubes, an electrode active material, or combinations thereof) that can be used may be determined by an electrical conductivity percolation point of the component.

The nanotubes can be single-walled carbon nanotube, a few-walled carbon nanotube, a multi-walled carbon nanotube, a double-walled carbon nanotube, or combinations thereof. These carbon nanotubes can be doped or non-doped which can be doped or undoped. The nanotubes and electrode active material is further discussed below.

Method 100 further includes directing the aerosolized nanotubes, aerosolized electrode active material, and aerosolized conductive metal to a substrate at operation 102 to form a self-standing electrode 120 (FIG. 1B) of a desired thickness and/or a desired density on the substrate 112.

Substrates utilized herein can be porous, non-porous, or semi-porous. The substrate can be flexible. As further described below, substrates can be made movable by utilizing a roll-to-roll system, thereby enabling continuous production of self-standing electrodes. Substrates on which self-standing electrodes described herein are formed or deposited can include a plurality of pores sized to allow passage of the carrier gas therethrough. The plurality of pores can be sized to prevent passage of self-standing electrode the composite therethrough. Substrates utilized herein can include a filter or a frit. Substrates described herein can be made of any suitable material such as cotton, polyolefins, nylons, acrylics, polyesters, fiberglass, polytetrafluoroethylene, or combinations thereof.

Referring back to method 100, the self-standing electrode can be treated at optional operation 105 to, for example, increase the density of the self-standing electrode, decrease the thickness of the self-standing electrode, or both. In some aspects, the method 100 can further include removing the self-standing electrode from the substrate 112 at optional operation 107 and as shown by the arrow in FIG. 1B. In some aspects, methods of forming self-standing electrodes described herein can further include cutting the self-standing electrode to the desired dimensions of, for example, a battery electrode.

Self-standing electrodes described herein comprise nanotubes, electrode active material, conductive metal, or combinations thereof. Self-standing electrodes described herein can be a composite, the composite comprising nanotubes, electrode active material, conductive metal, or combinations thereof. The conductive metal of a self-standing electrode described herein can be at least partially embedded, dispersed, or otherwise incorporated in the nanotubes of the self-standing electrode, the electrode active material of the self-standing electrode, or both. The conductive material can be in the form of a powder, a particle, a mesh, a wire, a strip, a foil, a sponge, a foam, or other suitable structures, or combinations thereof. Self-standing electrodes described herein can be self-supported and/or flexible. In some aspects, self-standing electrodes described herein can be free of binder. In some aspects, self-standing electrodes described herein can optionally be free of a metal-based current collector; that is self-standing electrodes described herein can be used without a metal-based current collector. See, for example, U.S. Patent Application Publication Nos. 2019/0036103 and 2020/0259160 and U.S. patent application Ser. Nos. 15/665,171 and 16/845,524, each of which is incorporated herein by reference in their entireties.

In some aspects, and during operation 101, the aerosolized nanotubes, electrode active material, and conductive metal can be combined to form an aerosolized mixture comprising nanotubes, electrode active material, and conductive metal. This aerosolized mixture can then be directed to the substrate 112 to form the self-standing electrode 120 on the substrate.

In some aspects, method 100 can include allowing the nanotubes, the electrode active material, the conductive metal, or a mixture thereof, in the carrier gas to flow through one or more tubes connecting the individual aerosolizing reactors (described below, for example, vessel 210b and/or vessel 210c), the nanotube reactor (described below, for example, vessel 210a), and the collection chamber (described below, for example, collection vessel 570). In some embodiments, the one or more tubes are at least about 0.5″ O.D. stainless tubing.

The self-standing electrode 120 shown in FIG. 1B illustrates aspects where the self-standing electrode 120 includes nanotubes, electrode active material, and conductive metal together. The conductive metal in self-standing electrode 120 can be in the form of a powder(s), a particle(s), or combinations thereof that is embedded, dispersed, or otherwise incorporated in the electrode active material of the self-standing electrode, the nanotubes of the self-standing electrode, or both. In some aspects, the conductive metal in self-standing electrode 120 can be in the form of a mesh, a wire, a strip, a foil, a sponge, a foam, or other suitable structures, or combinations thereof.

In some aspects, a method of making a self-standing electrode can include separately providing fluidized/aerosolized nanotubes, fluidized/aerosolized electrode active material, and fluidized/aerosolized conductive metal; and directing the fluidized/aerosolized nanotubes, the fluidized/aerosolized electrode active material, and the fluidized/aerosolized conductive metal to a substrate to form a self-standing electrode thereon. The amount of a component (a conductive metal, nanotubes, an electrode active material, or combinations thereof) used to form a self-standing electrode may be determined by an electrical conductivity percolation point of the component. The optional operations 105, 107 can be performed after forming the self-standing electrode.

In some aspects, which can be combined with other aspects, one or more of the fluidized/aerosolized nanotubes, fluidized/aerosolized electrode active material, and fluidized/aerosolized conductive metal are co-deposited onto the substrate.

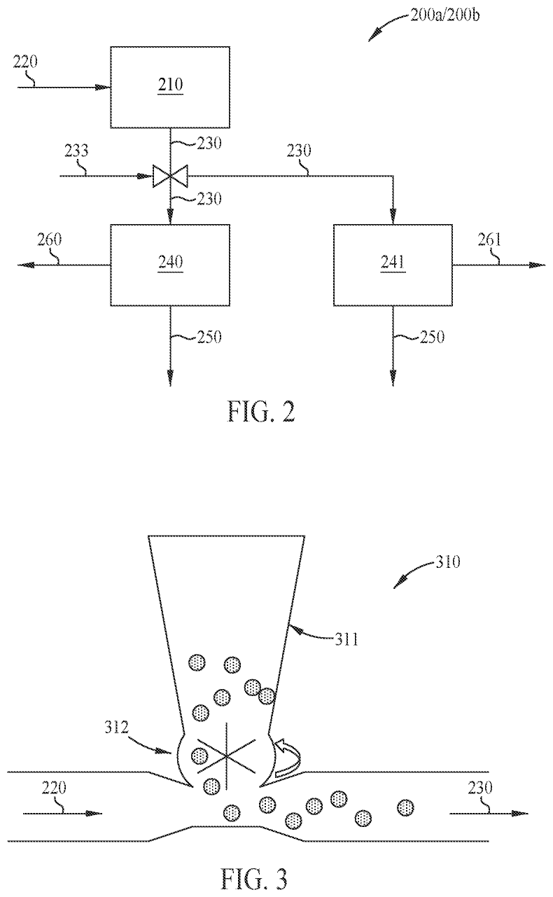

Aspects of the present disclosure also generally relate to apparatus for making self-standing electrodes. FIG. 2 is a flow diagram illustrating a non-limiting example of an apparatus 200a/200b (collectively, apparatus 200) for making a self-standing electrode according to an aspect of the present disclosure. The nanotubes, the electrode active material, and the conductive metal can be added to a vessel 210. The vessel 210 can be any suitable vessel such as a collection chamber, a mixer, among others. The nanotubes, the electrode active material, and the conductive metal can be individually collected from their respective manufacturing processes and directly or indirectly introduced from such processes into the vessel 210 at a desired ratio for the self-standing electrode. A carrier gas 220 (or plurality of carrier gases) can then be introduced to the vessel 210 to aerosolize the mixture of the nanotubes, electrode active material, and conductive metal. The resulting mixed aerosolized stream 230 comprising the nanotubes, electrode active material, and conductive metal entrained in the carrier gas(es) can be directed to a substrate 240, such as a porous substrate, such as a filter. The carrier gas(es) can pass through the substrate 240 as a gas stream 250 while the mixture of the nanotubes, the electrode active material, and the conductive metal is captured on the surface of the substrate 240 to form the self-standing electrode 260. The self-standing electrode 260 can be removed from the substrate 240 when, for example, it reaches the desired thickness. As used herein, the term “carrier gas” and “aerosolizing gas” are used interchangeably unless the context indicates otherwise.

In some aspects, the apparatus 200 is free of vessel 210. In such examples, an outlet (or a plurality of outlets) can be used. Here, for example, the nanotubes, electrode active material, and conductive metal entrained in carrier gas 220 can be fed through the outlet and onto the substrate 240.

In some aspects, the apparatus 200 can include a plurality of substrates 240, 241 to enable, for example, continuous production of self-standing electrodes 260, 261. The substrates 240, 241 can be porous or non-porous. Although only two substrates are shown, it is to be understood than any suitable number of substrates can be included in the apparatus 200. In an illustrative, but non-limiting example, when the flow of the mixed aerosolized stream 230 across the substrate 240 produces the self-standing electrode 260 of the desired thickness, a valve 233 can be adjusted to transfer the flow of the mixed aerosolized stream 230 to a second substrate 241. The self-standing electrode 260 can be removed from the first substrate 240 during formation of the self-standing electrode 261 on the substrate 241. When the flow of the mixed aerosolized stream 230 across the second substrate 241 produces the self-standing electrode 261 of a desired thickness, the valve 233 can be adjusted to transfer the flow of the mixed aerosolized stream 230 back to the first substrate 240. The thickness and/or cross-sectional area of the self-standing electrode 261 can be the same, or different, than the thickness and/or cross-sectional area of the self-standing electrode 260. For example, the self-standing electrode 261 can have a smaller thickness and/or cross-sectional area than the self-standing electrode 260.

Various suitable methods can be used for switching the valve 233 to redirect the flow of the mixed aerosolized stream 230 (or individual aerosolized streams) from one substrate to the other. Illustrative examples of systems that can be used to adjust the valve 233 to redirect the flow of the mixed aerosolized stream 230 include one or more sensors for detecting the thickness of the self-standing electrodes 260, 261, one or more pressure sensors for monitoring a pressure drop across the substrates 240, 241 that corresponds to a desired thickness of the self-standing electrodes 260, 261, a timer that switches the valve 233 after a set time corresponding to a desired thickness of the self-standing electrodes 260, 261 for a given flow rate of the mixed aerosolized stream 230, and any combination thereof. In some aspects, the mixed aerosolized stream 230 (or individual aerosolized streams) can be redirected from one substrate to the other after the one or more pressure sensors measures a pressure drop associated with the desired thickness of the self-standing electrode 260 and/or self-standing electrode 261 on substrate 240 and/or substrate 241; or after the one or more thickness sensors detect the desired thickness of the self-standing electrode 260 and/or self-standing electrode 261 on substrate 240 and/or substrate 241; or after the timer measures the set time corresponding to the desired thickness of the self-standing electrode 260 and/or self-standing electrode 261 on substrate 240 and/or substrate 241. It is also to be understood that the substrate 240 and/or the substrate 241 can have a cross-sectional area that matches, or substantially matches, the desired cross-sectional area required for use in a battery to be made with the self-standing electrode 260 and/or the self-standing electrode 261. Accordingly, the self-standing electrode 260 and/or the self-standing electrode 261 may be free of further processing of the cross-sectional area, such as cutting, before assembly in the final battery or final battery cell.

As discussed above, the vessel 210 can be any suitable vessel such as a collection chamber, a mixer, or combinations thereof, among other suitable structures. The configuration of the vessel 210 is not intended to be limited in any way. In an illustrative, but non-limiting, example as shown in FIG. 3, the vessel 310 can be a pneumatic powder/particle feeder, such as a venturi feeder that includes a hopper 311 for receiving the nanotubes, the electrode active material, and conductive metal therein. The vessel 310 can also include a rotary valve 312 that feeds the nanotubes, the electrode active material, and conductive metal into contact with the carrier gas 220 that is introduced to the vessel 310 to form the mixed aerosolized stream 230. In some aspects, vessel 310 can be used for vessel 210.

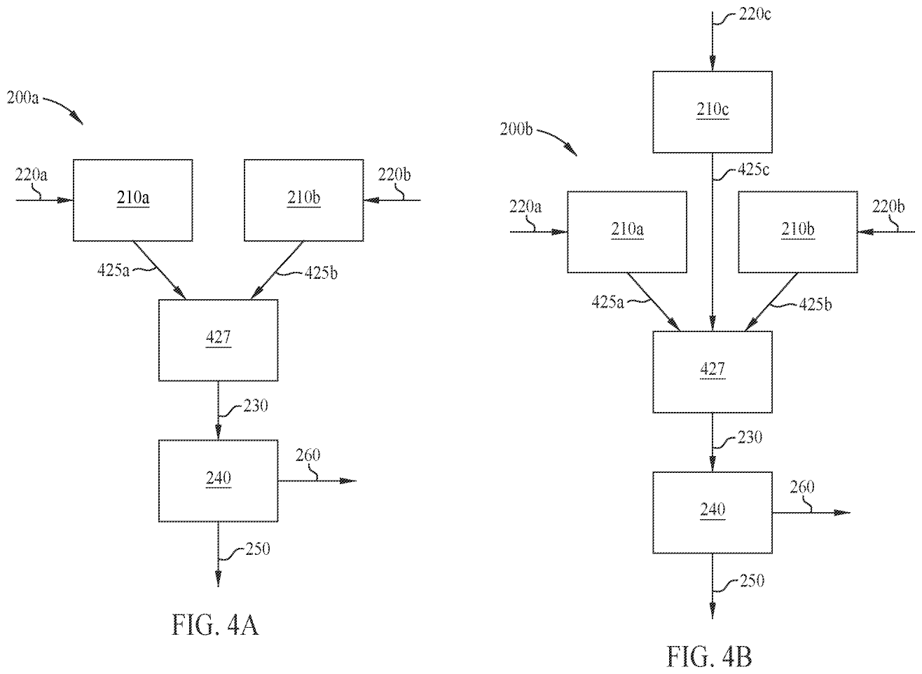

FIGS. 4A and 4B are flow diagrams illustrating non-limiting examples of apparatus 200a and apparatus 200b, respectively, for making a self-standing electrode according to at least one aspect of the present disclosure. The apparatus 200a shown in FIG. 4A can be used when the structure of the conductive metal in the self-standing electrode is in the form of, for example, a mesh, a wire, a strip, a foil, a sponge, a foam, or other suitable structures, or combinations thereof. The apparatus 200b shown in FIG. 4B can be used when the structure of the conductive metal in the self-standing electrode is in the form of a powder, a particle, or other suitable structures, or combinations thereof. It is contemplated that the apparatus 200a and/or apparatus 200b can be used for a powders, a particle, a mesh, a wire, a strip, a foil, a sponge, a foam, or other suitable structures, or combinations thereof. The apparatus 200b shown in FIG. 4B includes a separate, additional chamber from which the conductive metal is fed to vessel 210 (or, in some aspects, an outlet). The outlet can be a common outlet through which the nanotubes, electrode active material, and conductive metal flow through and onto the substrate. Alternatively, more than one outlet can be used.

As shown in FIG. 4A, the nanotubes and the electrode active material can be individually aerosolized or fluidized before mixing. For example, the nanotubes can be provided in the vessel 210a, while the electrode active material can be provided in the vessel 210b. The conductive metal (which is in the form of, for example, a mesh, a wire, a strip, a foil, a sponge, a foam, or other suitable structures, or combinations thereof) that forms a portion of the self-standing electrode is positioned on a substrate 240. In this form, the conductive metal can act as, for example, a porous frit.

An aerosolizing gas (carrier gas 220a), can be introduced to the vessel 210a to aerosolize the nanotubes, and an aerosolizing gas (carrier gas 220b) can be introduced to the vessel 210b to aerosolize the electrode active material. An aerosolized stream 425a comprises the nanotubes entrained in the carrier gas 220a introduced to the vessel 210a, and an aerosolized stream 425b comprises the electrode active material entrained in the carrier gas 220b introduced to the vessel 210b. The aerosolized stream 425a can be mixed with the aerosolized stream 425b at a collection vessel 427 (or collection chamber). The collection vessel 427 can have any suitable configuration capable of combining the aerosolized stream 425a and the aerosolized stream 425b into a mixed aerosolized stream 230 that comprises a mixture of the nanotubes and the electrode active material entrained in the carrier gases. The mixed aerosolized stream 230 is directed to the substrate 240 having the conductive metal positioned thereon. As described above, the conductive metal is in the form of, for example, a mesh, a wire, a strip, a foil, a sponge, a foam, or other suitable structures, or combinations thereof. The carrier gas(es) passes through the substrate 240 (and the conductive metal) as gas stream 250 while the mixture of the nanotubes and the electrode active material is captured on the surface of the substrate 240 and the conductive metal to form the self-standing electrode 260. The self-standing electrode 60 can be removed from the substrate 240 when it reaches the desired thickness. The individual carrier gases 220a, 220b can be the same, or different, and/or the individual carrier gases 220a, 220b can be introduced at the same or different flow rates. For example, the flow rates of the individual carrier gases 220a, 220b can be tailored to feed the nanotubes and the electrode active material to the collection vessel 427 at the individual flow rates necessary to achieve the desired ratio of nanotubes to electrode active material to conductive metal in the resulting self-standing electrode 260. Although not shown, it should be understood that more than one substrate 240 (for example, substrate 241) can be provided as described with respect to FIG. 2.

In some aspects, the nanotubes and the electrode active material are not mixed. In these and other aspects, the nanotubes and the electrode active material can be individually directed to the substrate 240, having the conductive metal disposed thereon, and individually deposited on the substrate 240 and the conductive metal.

Deposition of the nanotubes and the electrode active material can be a co-deposition of the nanotubes and the electrode active material, an individual deposition of the nanotubes, the electrode active material, or combinations thereof. The order of deposition is not limiting such that the nanotubes or the electrode active material can be performed before or after the other. Multiple depositions of the nanotubes and/or the electrode active material can be performed.

As shown in FIG. 4B, each of the nanotubes, the electrode active material, and the conductive metal can be individually aerosolized or fluidized before mixing. For example, the nanotubes can be provided in the vessel 210a, the electrode active material can be provided in the vessel 210b, and the conductive metal can be provided in the vessel 210c. Carrier gas 220a can be introduced to the vessel 210a to aerosolize the nanotubes, carrier gas 220b can be introduced to the vessel 210b to aerosolize the electrode active material, and carrier gas 220c can be introduced to the vessel 210c to aerosolize the conductive metal. An aerosolized stream 425a comprises the nanotubes entrained in the carrier gas 220a introduced to the vessel 210a, an aerosolized stream 425b comprises the electrode active material in the carrier gas 220b introduced to the vessel 210b, and an aerosolized stream 425c comprises the conductive metal in the carrier gas 220c introduced to the vessel 210c. One or more of the aerosolized streams 425a, 425b, or 425c can be mixed at collection vessel 427. The collection vessel 427 can have any configuration capable of combining the aerosolized streams 425a, 425b, or 425c into the mixed aerosolized stream 230 that comprises a mixture of the nanotubes, the electrode active material, and conductive metal entrained in the respective carrier gases. The mixed aerosolized stream 230 is directed to the substrate 240. The carrier gas passes through the substrate 240 as gas stream 250 while the mixture of the nanotubes, the electrode active material, and conductive metal is captured on the surface of the substrate 240 to form the self-standing electrode 260. The self-standing electrode 260 can be removed from the substrate 240 when it reaches the desired thickness. The individual carrier gases 220a, 220b, 220c can be the same, or different, and/or the carrier gases 220a, 220b, 220c can be introduced at the same or different flow rates. For example, the flow rates of the individual carrier gases 220a, 220b, 220c can be tailored to feed the nanotubes, the electrode active material, and the conductive metal to the collection vessel 427 at the individual flow rates necessary to achieve the desired ratio of nanotubes to electrode active material to conductive metal in the resulting self-standing electrode 260. Although not shown, it should be understood that more than one substrate 240 (for example, substrate 241) can be provided as described with respect to FIG. 2.

In some aspects, the nanotubes, the electrode active material, and/or the conductive metal are not mixed. In these and other aspects, the nanotubes, the electrode active material, and/or the conductive metal can be individually directed to the substrate 240 and individually deposited on the substrate 240.

Deposition of the nanotubes, the electrode active material, and/or the conductive metal can be a co-deposition of the nanotubes, the electrode active material, and/or the conductive metal, an individual deposition of the nanotubes, the electrode active material, and/or the conductive metal, or combinations thereof. The order of deposition is not limiting such that the nanotubes, the electrode active material, and/or the conductive metal can be performed before or after the other. Multiple depositions of the nanotubes, the electrode active material, and/or the conductive metal can be performed.

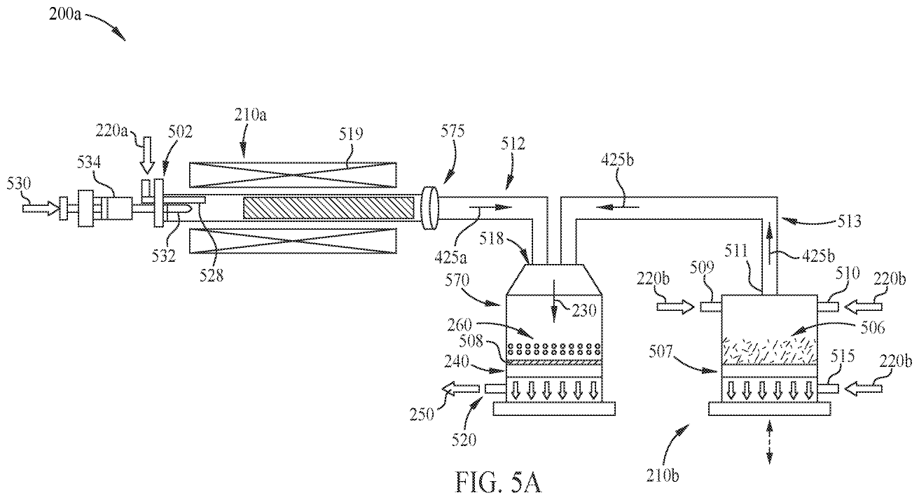

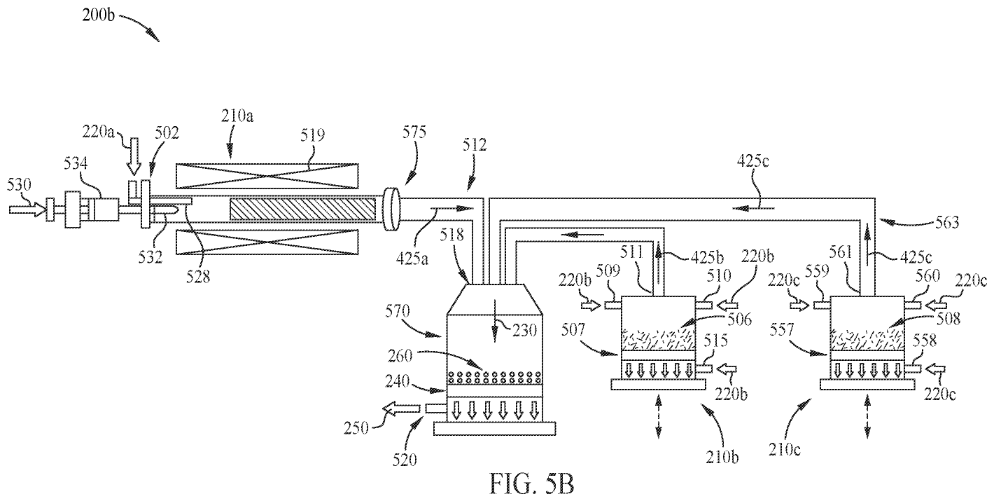

FIGS. 5A and 5B are schematic views of the apparatus 200a and the apparatus 200b, respectively, for making a self-standing electrode according to at least one aspect of the present disclosure. The apparatus shown in FIGS. 5A and 5B can be utilized for solution-free deposition of self-standing electrodes.

As shown in FIG. 5A, the nanotubes can be provided in an aerosolized stream 425a directly from the vessel 210a that is configured as a nanotube synthesis reactor for mixing with an aerosolized stream 425b of the electrode active material 506. Accordingly, the aerosolized stream 425a can be a product stream exiting the nanotube synthesis reactor. For example, a carbon and catalyst source 530 (or carbon and catalyst precursor) can be introduced to the vessel 210a via cylinder 534 in the presence of one or more carrier gases 220a to form nanotubes. The aerosolized stream 425a of nanotubes exits the reactor outlet 575 and travels through a tube 512 (or a pipe) to a collection vessel 570 via an inlet 518 where the aerosolized nanotubes are mixed with the aerosolized stream 425b of the electrode active material and conductive metal. In some aspects, an outlet (or plurality of outlets) can be used instead of a collection vessel 570. Although not shown, it is to be understood that more than one substrate 240, having a conductive metal 508 disposed thereon, (and collection vessel 570) can be provided as described with respect to FIG. 2. As described above, the conductive metal 508 is in the form of, for example, a mesh, a wire, a strip, a foil, a sponge, a foam, or other suitable structures, or combinations thereof.

In some aspects, vessel 210a is a nanotube reactor such as a quartz tube. The quartz tube can have any suitable dimensions such as dimensions of 25 mm OD×22 mm ID×760 mm length. The nanotube reactor (e.g., vessel 210a) can be aligned horizontally with a left end closed with a barrier 502. However, the nanotube reactor (e.g., vessel 210a) can be aligned vertically or at any suitable angle therebetween. At the center of barrier 502, a carrier gas inlet 528 can be provided for the carrier gas 220a and an inlet 532 can be provided for the carbon and catalyst source 530. The inlet 528 and/or the inlet 532 can be positioned to the left of the section of the nanotube reactor (e.g., vessel 210a) heated by a heat source 519.

The electrode active material 506 can be provided in an aerosolized stream 425b directly from the vessel 210b. The vessel 210b can be an aerosolizing chamber. The aerosolizing chamber (e.g., vessel 210b) includes an inlet 515 for bottom-up flow of aerosolizing gas (e.g., carrier gas 220b) and inlets 509, 510 for tangential flows of aerosolizing gas (e.g., carrier gas 220b). A frit 507 (or a filter, such as a porous frit or porous filter) is positioned inside the aerosolizing chamber and above inlet 515 such that a portion of the aerosolizing gas (e.g., carrier gas 220b) flows through frit 507. The aerosolized stream 425b of electrode active material 506 exits outlet 511 of the aerosolizing chamber (e.g., vessel 210b) and travels through a tube 513 (or pipe) to the collection vessel 570 where the aerosolized stream 425a of nanotubes are mixed with the aerosolized stream 425b of the electrode active material. In some aspects, an outlet (or plurality of outlets) can be used instead of the collection vessel 570.

The aerosolized streams 425a, 425b travel through the respective tubes 512, 513 and into the collection vessel 570 where the aerosolized nanotubes can be mixed with the aerosolized electrode active material to form the mixed aerosolized stream 230 of aerosolized nanotubes and electrode active material. The mixed aerosolized stream 230 deposits on the substrate 240, having the conductive metal 508 positioned thereon, as a self-standing electrode 260, as the carrier gases pass through substrate 240 and conductive metal 508 as a gas stream 250 and out an exhaust 520.

The apparatus 200b of FIG. 5B is similar to the apparatus 200a of FIG. 5A. However, apparatus 200b includes additional features, such as vessel 210c for aerosolizing the conductive metal 508 separate from the electrode active material 506. Here, vessel 210b is used to aerosolize the electrode active material 506, while vessel 210c is used to aerosolize the conductive metal 508. The electrode active material 506 can be provided in the aerosolized stream 425b from the vessel 210b. The conductive metal 508 can be provided in an aerosolized stream 425c directly from the vessel 210c. The vessel 210c can be an aerosolizing chamber. The aerosolizing chamber (e.g., vessel 210c) includes an inlet 558 for bottom-up flow of carrier gas 220c and inlets 559, 560 for tangential flows of carrier gas 220c. A frit 557 (or filter, such as a porous frit or porous filter) is positioned inside the aerosolizing chamber and above the inlet 558 such that a portion of the carrier gas 220c flows through frit 557. The aerosolized stream 425c of conductive metal 508 exits outlet 561 of the aerosolizing chamber (e.g., vessel 210c) and travels through a tube 563 (or pipe) to the collection vessel 570 where the aerosolized stream 425c of conductive metal 508 is mixed with the aerosolized stream 425a of nanotubes and the aerosolized stream 425b of the electrode active material 506.

As an alternative to the specific apparatus noted above where the electrode active materials and/or conductive metal(s) are mixed with the nanotubes after the nanotubes are formed, the electrode active materials and/or conductive metal(s) can be mixed in situ in a fluidized bed reactor or a chamber with the nanotubes as the nanotubes are formed.

In some aspects, an apparatus for producing a self-standing electrode of the present disclosure can include a nanotube synthesis reactor which produces nanotubes; a first aerosolizing reactor/chamber configured to aerosolize an electrode active material into an aerosolized electrode active material; a second aerosolizing reactor/chamber configured to aerosolize a conductive metal into an aerosolized conductive metal. The nanotube synthesis reactor, the first aerosolizing reactor/chamber, and the second aerosolizing reactor/chamber are fluidly coupled (or fluidly connected) to a collection vessel or collection chamber. When two or more elements are coupled or connected, the coupling or connection may be direct or indirect. In some aspects, a carrier gas is coupled to the nanotube synthesis reactor such that the carrier gas contacts nanotubes formed in the nanotube synthesis reactor and carries the nanotubes to the collection vessel/chamber. The collection vessel/chamber has a surface configured to collect the nanotubes, the electrode active material(s), the conductive metal(s), or a mixture thereof. The collection vessel/chamber is also configured to remove the carrier gas and/or aerosolizing gas(es) so as to form the self-standing electrode comprising the nanotubes, electrode active material(s), and conductive metal(s).

In some aspects, the electrode active material and the conductive material can be disposed in a single aerosolizing reactor such that the apparatus is free of the second aerosolizing reactor. In some examples, the apparatus can be configured to deposit one or more of the aerosolized nanotubes, electrode active material(s), or conductive metal(s) individually on the substrate.

The surface of the collection vessel/chamber can be configured to collect the nanotubes, the electrode active material(s), the conductive metal(s), or a mixture thereof and remove the carrier gas/aerosolizing gas(es) by any suitable means. The collecting surface can be a porous surface, including but not limited to a filter or a frit, where the pores are appropriately sized to permit passage of the carrier gas/aerosolizing gas(es) but not the mixture of nanotubes, electrode active material(s), and conductive metal(s). The carrier gas/aerosolizing gas(es) may be removed after passing through the surface and by way of an outlet. In some embodiments, removal of the carrier gas/aerosolizing gas(es) can be facilitated by a vacuum source.

In some aspects, the first aerosolizing reactor/chamber comprises a vertical shaker, one or more gas inlets, one or more outlets, a first porous frit, or combinations thereof. In some aspects, the second aerosolizing reactor comprises a vertical shaker, one or more gas inlets, one or more outlets, a second porous frit, or combinations thereof.

In some aspects, the first aerosolizing reactor, the second aerosolizing reactor, and the nanotube synthesis reactor can be upstream of the collection vessel/chamber. In at least one aspect, the first aerosolizing reactor, the second aerosolizing reactor, or both, can be downstream of the nanotube synthesis reactor and upstream of the collection vessel/chamber. In at least one aspect, the first aerosolizing reactor, the second aerosolizing reactor, or both, can be upstream of the nanotube synthesis reactor and upstream of the collection vessel/chamber. In some aspects, the first aerosolizing reactor, the second aerosolizing reactor, or both, can be coincident with the nanotube synthesis reactor and upstream of the collection vessel/chamber. In some aspects, at least two of the first aerosolizing reactor, the second aerosolizing reactor, or nanotube synthesis reactor are parallel to each other; and/or each of the first aerosolizing reactor, the second aerosolizing reactor, and nanotube synthesis reactor are upstream of the collection vessel/chamber.

All aspects described for the apparatus herein apply with equal force to the methods described herein, and vice-versa.

Carrier and fluidizing gases that are suitable for use with aspects of the present disclosure include, but are not limited to, hydrogen, nitrogen, noble gases (for example, helium, argon, among others), and combinations thereof. Carrier gases can be used at any suitable pressure and at any suitable flow rate to aerosolize the electrode active materials, the nanotubes, and the conductive materials, and transport the electrode active materials, the nanotubes, and the conductive materials individually or as an aerosolized mixture to the porous substrate at a sufficient velocity to form the self-standing electrode on the surface of the substrate. In some aspects, the carrier gas may be argon, hydrogen, helium, or mixtures thereof. In some aspects, the carrier gas may comprise argon at a flow rate of about 850 standard cubic centimeters per minute (sccm) and hydrogen at a flow rate of about 300 sccm. Other flow rates are contemplated. In at least one aspect, a flow rate of at least one of the carrier gases can be from about 100 sccm to about 10,000 sccm, such as from about 300 sccm to about 5,000 sccm, such as from about 600 sccm to about 2,000 sccm, such as from about 900 sccm to about 1,500. Any of the foregoing numbers can be used singly to describe an open-ended range or in combination to describe a close-ended range.

The type of nanotubes that are suitable for use with aspects of the present disclosure include nanotubes that are entirely carbon, or nanotubes that are substituted (doped) with atoms that are not carbon. Carbon nanotubes can be externally derivatized to include one or more functional moieties at a side and/or an end location. In some aspects, carbon and inorganic nanotubes include additional components such as metals or metalloids (for example, boron, silicon, among others), incorporated into the structure of the nanotube. In certain aspects, the additional components are a dopant, a surface coating, or are combinations thereof.

The nanotubes can be single-walled nanotubes, few-walled nanotubes, multi-walled nanotubes, double-walled nanotubes, or combinations thereof. As discussed above, these nanotubes can be doped or non-doped. Carbon nanotubes can range in length from about 50 nm to about 10 cm or greater, though longer or shorter carbon nanotubes are contemplated. Diameters of the carbon nanotubes can range from about 0.6 nm for single-walled carbon nanotubes to about 500 nm or greater for single-walled or multi-walled nanotubes, such as from about 1 nm to about 10 nm, though carbon nanotubes of longer or shorter diameters are contemplated. The carbon nanotube can be partially cylindrical, substantially cylindrical, or cylindrical. The carbon nanotubes can be partially hollow, substantially hollow, or hollow. Various other suitable nanotubes are contemplated.

The nanotubes may be metallic, semimetallic, or semi-conducting depending on, for example, the chirality of the nanotubes. The chirality of a carbon nanotube is indicated by the double index (n,m), where n and m are integers that describe the cut and wrapping of hexagonal graphite when formed into a tubular structure, as is known in the art. A nanotube of an (m,n) configuration is insulating. A nanotube of an (n,n), or “arm-chair”, configuration is metallic, and hence highly valued for its electric and thermal conductivity.

In an illustrative, but non-limiting, example, carbon nanotubes can be synthesized in a reactor or furnace from a carbon source in the presence of a catalyst, at a temperature of about 1000° C. to about 1500° C., such as from about 1100° C. to about 1400° C., such as from about 1200° C. to about 1300° C. In at least one example, the carbon nanotubes can be synthesized at a temperature of about 1300° C.

Any suitable catalyst can be used for the synthesis of carbon nanotubes. The catalyst particles can be present as an aerosol. In some aspects, the catalyst is supplied as particles, such as nanoparticles, that includes a transition metal, a lanthanide metal, an actinide metal, or combinations thereof. For example, the catalyst can include a Group VI transition metal such as chromium (Cr), molybdenum (Mo), and tungsten (W); a Group VIII transition metal such as iron (Fe), cobalt (Co), nickel (Ni), ruthenium (Ru), rhodium (Rh), palladium (Pd), osmium (Os), Iridium (Ir), and platinum (Pt). Other transition metals are contemplated. In some aspects, a combination of two or more metals are used, for example an iron, nickel, and cobalt mixture, such as a 50:50 mixture (by weight) of nickel and cobalt. The catalyst can include a pure metal, a metal oxide, a metal carbide, a nitrate salt of a metal, and/or other compounds containing one or more of the metals described herein. The catalyst can be added to the reactor at suitable amounts, such as from about 0.1 atom % to about 10 atom %, where atom % indicates the percentage of the number of catalyst atoms with respect to the total number of atoms in the reactor (catalyst and carbon precursor atoms). Other amounts of catalyst are contemplated.

Additionally, or alternatively, a catalyst precursor can be utilized, and the catalyst precursor can be converted to an active catalyst under the conditions of the reactor. The catalyst precursor can include one or more transition metal salts, lanthanide metal salts, actinide metal salts. Metal salts include metal nitrates such as a transition metal nitrate; acetates such as a transition metal acetate; cyanates such as a transition metal cyanate; acetylacetonates such as a transition metal acetylacetonate; citrates such as a transition metal citrate; fluorides such as a transition metal fluoride; chlorides such as a transition metal chloride; bromides such as a transition metal bromide; iodides such as a transition metal iodide; hydrates thereof; or combinations thereof. Other metal salts including those with different counterions are contemplated. In some examples, the catalyst precursor may be a metallocene, a metal acetylacetonate, a metal phthalocyanine, a metal porphyrin, a metal salt, a metalorganic compound, or combinations thereof. For example, the catalyst precursor may be a ferrocene, nickelocene, cobaltocene, molybdenocene, ruthenocene, iron acetylacetonate, nickel acetylacetonate, cobalt acetylacetonate, molybdenum acetylacetonate, ruthenium acetylacetonate, iron phthalocyanine, nickel phthalocyanine, cobalt phthalocyanine, iron porphyrin, nickel porphyrin, cobalt porphyrin, an iron salt, a nickel salt, cobalt salt, molybdenum salt, ruthenium salt, or combinations thereof. The catalyst precursor can include a soluble salt such as ferric nitrate (Fe(NO₃)₃), nickel nitrate (Ni(NO₃)₂), cobalt nitrate (Co(NO₃)₂), or combinations thereof dissolved in a liquid such as water. The catalyst precursor can achieve an intermediate catalyst state in the catalyst particle growth zone of the reactor, and subsequently become converted to an active catalyst upon exposure to the nanostructure growth conditions in the nanostructure growth zone of the reactor. For example, the catalyst precursor can be a transition metal salt that is converted into a transition metal oxide in the catalyst particle growth zone, then converted into active catalytic nanoparticles in the nanostructure growth zone.

The catalyst particles can include a transition metal, such as a d-block transition metal, an f-block transition metal, or combinations thereof. For example, the catalyst particles can include a d-block transition metal such as an iron, nickel, cobalt, gold, silver, or combinations thereof. The catalyst particles can be supported on a catalyst support. In aspects where the catalyst particles are on a catalyst support material, the catalyst support material can be introduced into the catalyst material prior to adding the catalyst to the reactor.

Carbon precursors or carbon sources that are suitable for forming carbon nanotubes (doped or un-doped) can include one or more carbon-containing gases, one or more hydrocarbon solvents, or mixtures thereof. Illustrative, but non-limiting, examples of carbon precursors and carbon sources can include hydrocarbon gases such as methane, acetylene, and ethylene; alcohols such as ethanol and methanol; aromatic solvents such as benzene and toluene; CO; and CO₂; and combinations thereof. A fuel for carbon nanotube synthesis and growth can include a mixture of one or more carbon precursors or carbon sources and one or more catalysts or catalyst precursors.

The fuel or precursor can be injected into the nanotube reactor (e.g., vessel 210a) at an injection rate of about 0.05 mL/min to about 1 mL/min, such as from about 0.1 mL/min to about 0.7 mL/min, such as from about 0.2 mL/min to about 0.5 mL/min, such as from about 0.3 mL/min to about 0.4 mL/min per injector, though other injection rates are contemplated. In at least one aspect, the fuel or precursor is injected into the nanotube synthesis reactor (e.g., vessel 210a) at an injection rate of about 0.1 mL/min or about 0.3 mL/min, per injector. In some aspects, more than one injector can be used, for example at large scale. The carrier gas flow rate can be from about 0.1 L/min to about 5 L/min, such as from about 0.2 L/min to about 2 L/min, such as from about 0.3 L/min to about 1 L/min, though other carrier gas flow rates are contemplated. If more than one carrier gas is utilized, each carrier gas can be used at the same or different flow rates. For example, the flow rate can be about 0.1 to about 5 L/min of hydrogen and/or about 0.2 to about 2 L/min helium or argon, such as about 5 L/min hydrogen, or 0.3 L/min hydrogen and about 1 L/min argon. Without wishing to be bound to any particular theory, helium or argon may be included in the carrier gas to dilute the hydrogen concentration, for example to keep the hydrogen concentration below the explosive limit. Selection of a fuel injection rate and/or a carrier gas flow rate can depend, for example, on the reactor volume. In some aspects, more than one reactor may be used in conjunction. In some aspects, the reactor temperature profile can include a starting low temperature, an increase to a peak or a maximum, and then a decrease to a temperature such as a decrease to the starting low temperature. Without wishing to be bound by any particular theory, for a given reactor temperature profile, the injector position (for example, the position of inlet 528 and/or the position of the inlet 532) inside the reactor should be correlated with the precursor temperature so that the precursor evaporates from the point of injection, without droplet formation or decomposition, as can be determined by those of ordinary skill in the art, considering for example the boiling point and decomposition. In some embodiments, the injector tip (for example, the tip of the inlet 528 and/or the tip of the inlet 532) can be inserted into the nanotube synthesis reactor (e.g., vessel 210a), for example, by about 5 inches to about 10 inches such as from about 6 inches to about 9 inches, such as about 7 inches to about 8 inches. The injection temperature, at the tip of the injector, can depend on, for example, the temperature of the nanotube synthesis reactor, the depth of insertion of the injector into the nanotube synthesis reactor, or combinations thereof. In some embodiments, the injection temperature at the tip of one or more of the injectors is about 500° C. to about 1,000° C., such as from about 600° C. to about 900° C., such as from about 700° C. to about 800° C., such as about 750° C. The nanotube synthesis reactor (e.g., vessel 210a) can be run for any suitable length of time to obtain the product composition and thickness desired, as can be determined by those of ordinary skill in the art, for example as long as there are starting materials.

Carbon nanotubes synthesized according to one or more aspects of the present disclosure can be characterized using any suitable means known in the art, including but not limited to derivative thermogravimetric analysis (DTG) and Raman spectroscopy, such as for calculation of the G/D ratio, as is disclosed in U.S. Patent Application Publication No. 2009/0274609, which is incorporated herein by reference in its entirety. Raman spectra of SWNTs have three major peaks, which are the G-band at about 1590 cm⁻¹, D-band at about 1350 cm⁻¹, and the radial breathing mode (RBM) at about 100-300 cm⁻¹. RBM frequency is proportional to an inverse of the diameter of SWNTs and can thus be used to calculate the diameter of the SWNT. Normally, a red shift in RBM peak corresponds to an increase in the mean diameter of SWNTs. The tangential mode G-band related to the Raman-allowed phonon mode E_{2g} can be a superposition of two peaks. The double peak at about 1593⁻¹ and about 1568 cm⁻¹ has been assigned to semiconductor SWNTs, while the broad Breit-Wigner-Fano line at about 1550 cm has been assigned to metallic SWNTs. Thus, the G-band provides a method for distinguishing between metallic and semiconducting SWNTs. The D-band structure is related to disordered carbon, the presence of amorphous carbon, and other defects due to the sp²-carbon network. The ratio of the G-band to D-band in the Raman spectra (I_{G}:I_{D} or G/D ratio) of SWNTs can be used as an index to determine the purity and quality of the SWNTs produced. In some aspects, I_{G}:I_{D} is about 1 to about 500, such as from about 5 to about 400, such as from about 7 to about 300, though other values are contemplated. In at least one aspect, I_{G}:I_{D} is about 7 or more.

Collecting the nanotubes, electrode active material, and conductive metal, individually or as a mixture, on a surface and removing the carrier gas can be carried out by any suitable means. The collecting surface of the substrate 240, 241 (such as a porous substrate) can be a porous surface, including but not limited to a filter or a frit, where the pores are appropriately sized to retain the nanotubes, the electrode active material, and the conductive metal thereon to form the self-standing electrode while permitting passage of the carrier and fluidizing gases through the substrate 240, 241. The carrier and fluidizing gases can be removed after passing through the surface of the substrate 240, 241 and by way of an outlet (for example, exhaust 520). In some aspects, removal of the carrier gas can be facilitated by a vacuum source coupled to the outlet. With respect to filters, the filters can be in the form of a sheet. The filters can include a variety of different materials including woven and non-woven fabrics. Illustrative, but non-limiting, examples of materials used for the filter can include cotton, polyolefins, nylons, acrylics, polyesters, fiberglass, polytetrafluoroethylene (PTFE), combinations thereof, among others. To the extent the substrate 240, 241 is sensitive to high temperatures, one or more of the aerosolized streams 425a, 425b, or 425c can be precooled with dilution gases having a lower temperature and/or by directing one or more of the aerosolized streams 425a, 425b, or 425c through a heat exchanger prior to contacting the substrate 240, 241.

In some aspects, the aerosolizing of the electrode active material includes distributing an aerosolizing gas through a porous frit (for example, frit 507) and a bed of electrode active material (for example, electrode active material 506), in an aerosolizing chamber (for example, vessel 210b), to produce the aerosolized electrode active material powder (for example, the aerosolized stream 425b of the electrode active material 506).

The aerosolizing chamber (for example, vessel 210b) can be constructed with an appropriately sized porous frit such that aerosolizing gas can pass through to enable aerosolization of the electrode active material but that does not permit the electrode active material to fall through the pores. The aerosolizing chamber for aerosolizing the electrode active material is not limited to any particular configuration. Illustrative, but non-limiting, examples of aerosolizing gases for aerosolizing the electrode active material can include, nitrogen, a noble gas (for example, argon, helium, among others), or combinations thereof. In some aspects, the aerosolizing gas for aerosolizing the electrode active material can be the same as the carrier gas. Alternatively, and in some aspects, the aerosolizing gas for aerosolizing the electrode active material can be the same as the carrier gas.

The electrode active material can be any suitable solid powder or solid particles that are capable of being aerosolized. In some aspects, the electrode active material for an anode can include, for example, graphite, graphene, hard carbon, silicon, a porous material that matches or substantially matches the potential of the given cathode material, natural graphite, artificial graphite, activated carbon, carbon black, high-performance powdered graphene, among others, and combinations thereof, such as Si, SiOx/C, graphite, or combinations thereof. Other electrode active materials for the anode are contemplated.

In some aspects, the electrode active material for a cathode can include, for example, a metal oxide, a lithium metal oxide, a lithium metal, among others, or combinations thereof. In at least one aspect, the electrode active material for a cathode can include lithium metal oxides, lithium iron phosphate, or combinations thereof. In some aspects, metals in lithium metal oxides according to the present disclosure can include, but are not limited to, one or more alkali metals, alkaline earth metals, transition metals, aluminum, or post-transition metals, hydrates thereof, or combinations thereof. Non-limiting examples of lithium metal oxides include lithiated oxides of Ni, Mn, Co, Al, Mg, Ti, alloys thereof, or combinations thereof. In an illustrative example, the lithium metal oxide is lithium nickel manganese cobalt oxide (LiNiₓMn_{y}Co_{z}O₂, x+y+z=1), Li(Ni,Mn,Co)O₂, or Li—Ni—Mn—Co—O. The lithium metal oxide can be in the form of a powder. The lithium metal oxide powder can have a particle size defined within a range between about 1 nanometer (nm) and about 100 microns (μm), or any integer or subrange in between. In a non-limiting example, the metal oxide and/or lithium metal oxide powders/particles can have a particle size defined within a range of about 1 nm to about 100 μm, such as from about 1 μm to about 10 μm or from about 1 nm to about 10 nm. In a non-limiting example, the metal oxide and/or lithium metal oxide powders/particles can have an average particle size of about 1 nm to about 100 μm, such as from about 1 μm to about 10 μm or from about 1 nm to about 10 nm. In some aspects, an electrode active material for a cathode can include LiFePO₄, LiCoO₂, Li—Ni—Mn—Co—O, or combinations thereof. Other materials for the electrode active material for a cathode are contemplated. In some embodiments, the electrode active material is lithium nickel manganese cobalt oxide (LiNiMnCoO₂).

“Alkali metals” are metals in Group I of the periodic table of the elements, such as lithium, sodium, potassium, rubidium, cesium, or francium. “Alkaline earth metals” are metals in Group II of the periodic table of the elements, such as beryllium, magnesium, calcium, strontium, barium, or radium. “Transition metals” are metals in the d-block of the periodic table of the elements, including the lanthanide and actinide series. Transition metals include, but are not limited to, scandium, titanium, vanadium, chromium, manganese, iron, cobalt, nickel, copper, zinc, yttrium, zirconium, niobium, molybdenum, technetium, ruthenium, rhodium, palladium, silver, cadmium, lanthanum, cerium, praseodymium, neodymium, promethium, samarium, europium, gadolinium, terbium, dysprosium, holmium, erbium, thulium, ytterbium, lutetium, hafnium, tantalum, tungsten, rhenium, osmium, iridium, platinum, gold, mercury, actinium, thorium, protactinium, uranium, neptunium, plutonium, americium, curium, berkelium, californium, einsteinium, fermium, mendelevium, nobelium, and lawrencium. “Post-transition metals” include, but are not limited to, gallium, indium, tin, thallium, lead, bismuth, or polonium.

As described above, methods of the present disclosure (for example, method 100) can include treating the self-standing electrode by, for example, pressing the self-standing electrode. Without wishing to be bound to any particular theory, pressing may increase the density and/or lower the thickness of the self-standing electrode, which may improve such properties as rate performance, energy density, and battery life. Pressing of the self-standing electrode can be carried out by applying a force to achieve a desired thickness and/or density, such as by using a rolling press or calendaring machine, platen press, or other suitable means. Any suitable force can be applied to the self-standing electrode, to achieve a desired thickness, a desired density, and/or a desired impedance, such as but not limited to a force of about 1 ton, about 2 tons, about 3 tons, about 4 tons, about 5 tons, about 6 tons, about 7 tons, about 8 tons, about 9 tons, about 10 tons, about 15 tons, or any integer or range thereof or in between, such as between about 7 tons and about 10 tons. In some aspects, pressing can include pressing the self-standing electrode to a thickness of about 20 microns, about 30 microns, about 40 microns, about 50 microns, about 60 microns, about 70 microns, about 80 microns, about 90 microns, about 100 microns, about 150 microns, about 200 microns, about 250 microns, about 300 microns, about 350 microns, about 400 microns, or any integer or range thereof or in between. Without wishing to be bound by any particular theory, too thick of a self-standing electrode can be slow to produce energy or may not be suitably flexible. In some aspects, it can be desirable to obtain an electrode foil that is flexible without formation of oxide or cracks. If the electrode is too thin, energy production may be rapid but it may be the case that not enough energy is produced. In addition, it can be desirable to regulate the distance between the rolls or rollers in a rolling press or calendaring machine, or between the plates of a platen press, by any suitable means known to those of ordinary skill in the art.

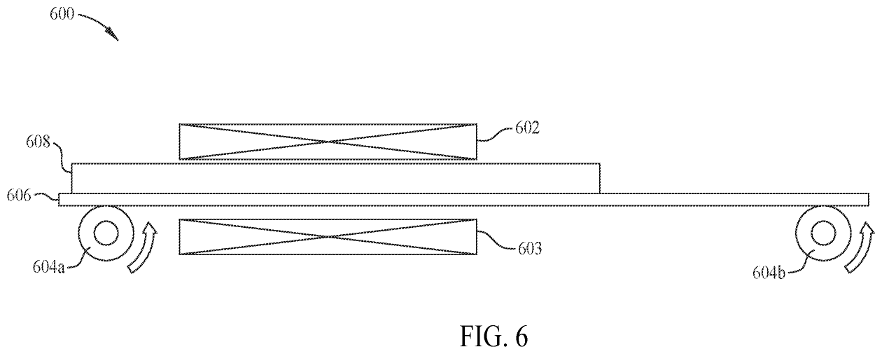

In some aspects, apparatus described herein may include one or more components to render the substrate movable. Here, and as shown in FIG. 6, the substrate 606 may be attached to a conveyor belt or a roll-to-roll system, such as apparatus 600. In these and other aspects, the substrate may be flexible and/or porous. The rate of motion of the movable substrate 606 may be controllable, such as by a computer or manually by an operator. Control of the rate of motion may enable or facilitate control of the thickness of the self-standing electrode obtained. Suitable porous flexible substrates, including but not limited to a filter or a frit, have pores appropriately sized so as to not permit passage of the self-standing electrode. In some embodiments, the pores may be sized to permit passage of carrier gases and/or fluidizing gases.

The apparatus 600 includes rollers 604a, 604b to move the substrate 606 having a self-standing electrode 608 formed thereon through a heat treatment via a heater 602 (for example, a furnace) and a pressing treatment via a plate of a platen press 603. Although the heater 602 and plate of a platen press 603 are shown as being on one side of the movable substrate 606, another heater and/or another plate of a platen press can be positioned on the other side of the movable substrate 606. Although the self-standing electrode is shown as a single layer (e.g., self-standing electrode 120), it should be understood that the self-standing electrode can include more than one layer if desired. In some examples, the apparatus 600 can be useful for forming self-standing electrodes that include the conductive metal in the form of a powder, a particle, a mesh, a wire, a strip, a foil, a sponge, a foam, or other suitable structures, or combinations thereof. In some aspects, and after depositing the nanotubes, electrode active material, and conductive metal individually or as a mixture on top of movable substrate 606, the formed self-standing electrode 608 can be heated and or pressed to a desired thickness, density, impedance.

In some aspects, movable substrate 606 corresponds to substrate 240, 241 and the apparatus 600 can be combined with apparatus 200a or apparatus 200b such that the methods and apparatus for producing self-standing electrodes is continuous. In these and other aspects, an outlet (or plurality of outlets) can be used instead of collection vessel 570. During production of the self-standing electrodes, the nanotubes, electrode active material(s), and conductive metal(s) can be directly deposited from the outlet(s) and onto a substrate attached to the roll-to-roll system in a same or similar manner as described in U.S. Patent Application Publication Nos. 2019/0036102, 2021/0296629, 2022/0140306, and U.S. patent application Ser. Nos. 15/665,142 and 17/334,647, each of which is incorporated herein by reference in their entireties.

As a non-limiting example, the nanotubes, electrode active material 506, and conductive metal 508, entrained within their respective aerosolized streams 425a, 425b travel through the respective tubes 512, 513 and are deposited onto a movable substrate 606 (which may be flexible and/or porous). The aerosolized streams 425a, 425b can be mixed prior to deposition onto the movable substrate 606. As another non-limiting example, the nanotubes, electrode active material 506, and conductive metal 508, entrained within their respective aerosolized streams 425a, 425b, 425c travel through the respective tubes 512, 513, 563 and are deposited onto the movable substrate 606 (which may be flexible and/or porous). One or more of the aerosolized streams 425a, 425b, 425c may be mixed prior to deposition onto the movable substrate.

Apparatus 600 can be utilized for forming any suitable self-standing electrode described here, including in combination with other apparatus described herein, and one or more methods described herein.

Accordingly, and in some aspects, methods of making a self-standing electrode can include aerosolizing/fluidizing nanotubes, aerosolizing/fluidizing an electrode active material, and aerosolizing/fluidizing a conductive material; mixing two or more of the aerosolized/fluidized nanotubes, the aerosolized/fluidized electrode active material, and the aerosolized/fluidized conductive material; and co-depositing two or more of the aerosolized/fluidized nanotubes, the aerosolized/fluidized electrode active material, and the aerosolized/fluidized conductive material onto a movable substrate (which may be flexible and/or porous) to form a self-standing electrode thereon. The amount of a component (a conductive metal, nanotubes, an electrode active material, or combinations thereof) used to form a self-standing electrode may be determined by an electrical conductivity percolation point of the component. In some aspects, the self-standing electrode formed can be a composite of the nanotubes, electrode active material, and conductive material. The method can be made continuous.

In some aspects, an apparatus for making a self-standing electrode can include a nanotube synthesis reactor configured to synthesize nanotubes; an electrode active material container configured to aerosolize an electrode active material; a conductive material container to aerosolize a conductive metal; a movable substrate configured to collect the aerosolized nanotubes, the aerosolized electrode active material, and the aerosolized conductive material and form the self-standing electrode. In some aspects, the self-standing electrode can be a composite of the nanotubes, electrode active material, and conductive material. The apparatus can be utilized for continuous processing.

A density of a self-standing electrode described herein following pressing can be increased by about 40% to about 125% of the density of the untreated self-standing electrode or the density of the self-standing electrode following collection on the substrate. That is, a treated self-standing electrode described herein can have a density that is 40% to 125% greater than the density of the untreated self-standing electrode (or the density of the self-standing electrode following collection on the substrate), such as from about 40% to about 90% greater than the density of the untreated self-standing electrode or from about 45% to about 75% greater than the density of the untreated self-standing electrode (or the density of the self-standing electrode following collection on the substrate. Other densities are contemplated.

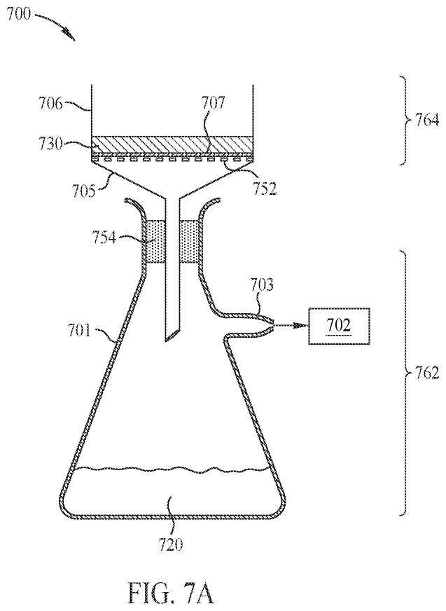

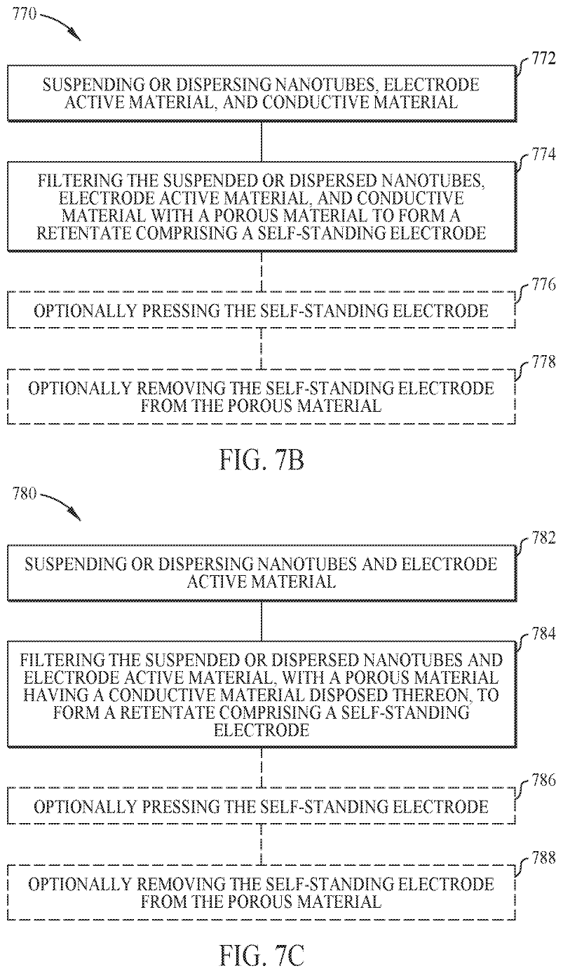

FIG. 7A is a schematic illustration of an example of an apparatus 700 for making a self-standing electrode according to at least one aspect of the present disclosure. The apparatus 700 shown in FIG. 7A can be utilized for wet deposition (for example, dispersion-based or suspension-based deposition) of self-standing electrodes.

The apparatus 700 is generally a filtration apparatus. The apparatus 700 includes a container 701 (e.g., a filter flask) connected to a vacuum source 702 via tubing (not shown). The apparatus 700 has a retentate side 764 (retentate labeled as 730) where a mixture of nanotubes, electrode active material, and conductive material can be retained, and a filtrate side 762. In some aspects, the retentate 730 includes or consists of a mixture of nanotubes, electrode active material, and conductive material. In some aspects, the retentate 730 is the self-standing electrode.

A porous material 752 defines the retentate side 764 and the filtrate side of the apparatus 700. The porous material 752 can be those substrates described herein, for example, substrate 112, 240, 241, 606. The filtrate side 762 includes the container 701 (filtrate labeled as 720), where the filtrate is collected after passing through a porous material 752 such as a porous film, porous membrane, or other suitable porous material. The retentate side 764 includes an element 706 (e.g., a funnel). Element 706 can be any suitable shape or volume. In some aspects, a portion of element 706 has a different diameter or area above and below the porous material 752, which is shown in FIG. 7A as numeral 705 (where the diameter of the element 706 changes).

In some aspects, the porous material 752 is porous to a liquid medium of a solution (e.g., solvent, surfactant, or salt, etc.) and is impervious (or substantially impervious) to the formed self-standing electrode. The element 706 can be coupled to the container 701 by a stopper 754. The filtration apparatus 700 can also include one or more gaskets (not shown), such as polytetrafluoroethylene (PTFE) gaskets. One gasket can be placed under the mesh frit and another gasket can be placed on top of the porous material 752.

The filtration apparatus 700 further includes a vacuum source 702 coupled to the filtrate side 762 of the filtration apparatus 700 via tubing (not shown), e.g., vacuum tubing. The vacuum source 702 draws filtrate through the porous material 752 at a desired rate to the container 701.

In some examples, a conductive material 707 is positioned above the porous material 752 in the retentate side 764 of the porous material. The conductive material 707 can be in the form of a mesh, a wire, a strip, a foil, a sponge, a foam, or other suitable structures, and is used as the conductive material of the self-standing electrode. In such examples, suspension(s)/dispersion(s) of nanotubes and electrode active material(s) are added to the apparatus to form a retentate on the mesh (or other structure) of conductive material disposed on the porous material 752 (substrate). The resulting self-standing electrode comprises the nanotubes, electrode active material, and the conductive material, the conductive material being in the form of a mesh, a wire, a strip, a foil, a sponge, a foam, combinations thereof, or other suitable structures or similar structure.

When the conductive material is in the form of a powder, a particle, or combinations thereof (or other suitable structure) and/or when the conductive material 707 is absent from the apparatus (e.g., when conductive material 707 is not utilized for the conductive material of the self-standing electrode). In such examples, suspension(s)/dispersion(s) of nanotubes, electrode active material(s), and conductive material(s) are added to the apparatus to form a retentate on the porous material 752 (e.g., a porous or semi-porous substrate). The resulting self-standing electrode comprises the nanotubes, electrode active material, and the conductive material.

For this wet deposition apparatus, suspension(s)/dispersion(s) of nanotubes, electrode active material, and conductive material can be utilized.

Suspension(s)/dispersion(s) of nanotubes that can be used with apparatus 700 can include a surfactant, a salt, a solvent, or combinations thereof, in addition to nanotubes. A nanotube suspension/dispersion ready for filtration is prepared by combining a nanotube described herein with an appropriate surfactant, salt, solvent, or combinations thereof and mixing via, for example, sonication or other suitable mixing techniques. A nanotube (single-walled carbon nanotube, SWCNT) suspension/dispersion ready for filtration is prepared according to the following non-limiting procedure. Different SWCNT-fabricated types can be used, such as laser oven, high-pressure carbon monoxide (HiPCO), cobalt-molybdenum catalyst (CoMoCAT), arc-discharge, etc. Electric arc-discharge SWCNTs are dispersed via sonication (e.g., tip sonication) in a suspension/dispersion. Alternatively, the nanotubes may be made using a nanotube synthesis reactor as described herein and then dispersed in a suspension/dispersion.

In some aspects, a concentration of nanotubes in the nanotube suspension/dispersion can be from about 0.1 g/L to about 2 g/L, such as from about 0.3 g/L to about 1.5 g/L, such as from about 0.5 g/L to about 1 g/L. In some aspects, a concentration of nanotubes in the nanotube suspension/dispersion (in g/L) can be 0.1, 0.2, 0.3, 0.4, 0.5, 0.6, 0.7, 0.8, 0.9, 1, 1.1, 1.2, 1.3, 1.4, 1.5, 1.6, 1.7, 1.8, 1.9, or 2, or ranges thereof, though higher or lower amounts are contemplated. Each of the foregoing numbers can be preceded by the word “about,” “at least about,” “less than about,” or “more than about,” and any of the foregoing numbers can be used singly to describe an open-ended range or in combination to describe a close-ended range.

In some aspects, a concentration of surfactant in the nanotube suspension/dispersion can be from about 1 wt % to about 5 wt %, such as from about 1.5 wt % to about 3 wt %, such as from about 2 wt % to about 2.5 wt %. In some aspects, a concentration of surfactant in the nanotube suspension/dispersion (in wt %) can be 1, 1.5, 2, 2.5, 3, 3.5, 4, 4.5, or 5, or ranges thereof, though higher or lower amounts are contemplated. Each of the foregoing numbers can be preceded by the word “about,” “at least about,” “less than about,” or “more than about,” and any of the foregoing numbers can be used singly to describe an open-ended range or in combination to describe a close-ended range.

Suspensions/dispersions of electrode active material that can be used with apparatus 700 can include a solvent, a surfactant, or combinations thereof, in addition to the electrode active material. A suspension/dispersion comprising the electrode active material ready for filtration can be prepared by combining an electrode active material described herein with an appropriate surfactant, salt, solvent, or combinations thereof and mixing via, for example, sonication or other suitable mixing techniques.

In some aspects, a concentration of electrode active material in the electrode active material suspension/dispersion can be from about 1 g/L to about 20 g/L, such as from about 3 g/L to about 15 g/L, such as from about 5 g/L to about 10 g/L. In some aspects, a concentration of nanotubes in the nanotube suspension/dispersion (in g/L) can be 1, 2, 3, 4, 5, 6, 7, 8, 9, 10, 11, 12, 13, 14, 15, 16, 17, 18, 19, or 20, or ranges thereof, though higher or lower amounts are contemplated. Each of the foregoing numbers can be preceded by the word “about,” “at least about,” “less than about,” or “more than about,” and any of the foregoing numbers can be used singly to describe an open-ended range or in combination to describe a close-ended range.

In some aspects, a concentration of surfactant in the electrode active material suspension/dispersion can be from about 1 wt % to about 5 wt %, such as from about 1.5 wt % to about 3 wt %, such as from about 2 wt % to about 2.5 wt %. In some aspects, a concentration of surfactant in the electrode active material suspension/dispersion (in wt %) can be 1, 1.5, 2, 2.5, 3, 3.5, 4, 4.5, or 5, or ranges thereof, though higher or lower amounts are contemplated. Each of the foregoing numbers can be preceded by the word “about,” “at least about,” “less than about,” or “more than about,” and any of the foregoing numbers can be used singly to describe an open-ended range or in combination to describe a close-ended range.

Suspensions/dispersions of conductive material that can be used with apparatus 700 can include a solvent in addition to the conductive material. A suspension/dispersion comprising the conductive material ready for filtration can be prepared by combining a conductive material described herein with an appropriate solvent and mixing via, for example, sonication or other suitable mixing techniques.

In some aspects, a concentration of conductive material in the conductive material suspension/dispersion can be from about 1 g/L to about 20 g/L, such as from about 3 g/L to about 15 g/L, such as from about 5 g/L to about 10 g/L. In some aspects, a concentration of nanotubes in the nanotube suspension/dispersion (in g/L) can be 1, 2, 3, 4, 5, 6, 7, 8, 9, 10, 11, 12, 13, 14, 15, 16, 17, 18, 19, or 20, or ranges thereof, though higher or lower amounts are contemplated. Each of the foregoing numbers can be preceded by the word “about,” “at least about,” “less than about,” or “more than about,” and any of the foregoing numbers can be used singly to describe an open-ended range or in combination to describe a close-ended range. The amount of conductive material used can depend on the aspect ratio of the particles.

Useful surfactants for making the nanotube suspension/dispersion, can include surfactants having sulfate groups or carboxylate groups such as sodium dodecyl sulfate (SDS). Additionally, or alternatively, other surfactants can be used, and/or detergents, salts, and/or anionic dispersants can be used. These include sodium deoxycholate (DOC), sodium dodecyl benzyl sulfonate (SDBS), sodium cholate, and/or other di and tri-hydroxy bile salt variants including sodium taurocholate, sodium glycocholate, sodium taurodeoxycholate, sodium glycodeoxycholate, sodium chenodeoxycholate, and sodium ursodeoxycholate, or combinations thereof. Other surfactants, detergents, and salts are contemplated. Selection of the surfactant depends on, for example, the solvent. The surfactant can help prevent agglomeration or bundling of the nanotubes.

Useful solvents for forming the nanotube suspension/dispersion, the electrode active material suspension/dispersion, and/or the conductive material suspension/dispersion can include a solvent. Illustrative, but non-limiting, examples of solvent include organic solvents such as ketone solvents (e.g., N-methyl-2-pyrrolidone, acetone, etc.), alcohol solvents (e.g., methanol, ethanol, isopropanol), halogenated solvents (e.g., chloroform, methylene chloride, etc.), hydrocarbon solvents (e.g., pentane, hexane, heptane (C₇H₁₆), and/or octane, and isomers thereof, such as dimethylpentane), aromatic solvents (e.g., toluene), and combinations thereof. In some aspects, aqueous solvents can be utilized. Combinations of one or more solvents can be utilized. Other solvents are contemplated.

In operation, and in some aspects, suspension(s)/dispersion(s) of the nanotubes, electrode active material, and/or the conductive material are introduced to the element 706 (e.g., a funnel) of the filtration apparatus (e.g., apparatus 700). A vacuum (or negative pressure), of a suitable amount of pressure, can be applied to the filtrate side 762 of the filtration apparatus. The desired pressure(s) can be set for controlled flow rates. In some aspects, the vacuum pressure applied from the vacuum source 702 can be from about 1 atm (˜0.1 MPa) to about 50 atm (˜5 MPa), such as from about 2 atm (˜0.2 MPa) to about 30 (˜ 3 MPa), such as from about 3 atm (˜0.3 MPa) to about 10 atm (˜1 MPa), such as from about 5 atm (˜0.5 MPa) to about 8 atm (˜0.8 MPa), though other pressures are contemplated. The desired flow rate of the liquid mediums (the liquid suspending or dispersing the nanotubes, electrode active material, and/or conductive material) passing through the porous material 752 can depend on, e.g., the scale of the apparatus 700, the pore size of the porous material 752, among other factors.

Aspects of the present disclosure also relate to methods of making a self-standing electrode by a suspension- or dispersion-based process (or other wet deposition processes). FIG. 7B is a flowchart showing selected operations of a method 770 of making a self-standing electrode according to at least one aspect of the present disclosure. Method 770 is an illustrative, but non-limiting, method that can be utilized with apparatus 700. In some aspects, method 770 can be utilized when the conductive material is in the form of a powder, a particle, or combinations thereof, and/or when the conductive material 707 is absent from the apparatus (e.g., when conductive material 707 is not utilized for the conductive material of the self-standing electrode).

Method 770 includes suspending or dispersing nanotubes, electrode active material, and conductive material at operation 772. Conductive materials include those conductive metals and other conductive materials such as alloys described herein, among others, such as Cu, Al, Ni, Pt, Zn, Ti, stainless steel, sintered carbon, or combinations thereof. Nanotubes and electrode active material include those nanotubes and electrode active material described herein, among others. The amount of a component (a conductive metal, nanotubes, an electrode active material, or combinations thereof) used to form a self-standing electrode may be determined by an electrical conductivity percolation point of the component. In some aspects, the nanotubes, electrode active material, and/or conductive material can be in the same suspension/dispersion or different suspensions/dispersions. Materials useful to solubilize or suspend the nanotubes, electrode active material, and/or conductive material include, but are not limited to, those materials described above.

Method 770 further includes filtering the suspended/dispersed nanotubes, suspended/dispersed electrode active material, suspended/dispersed conductive metal, or combinations thereof with a porous material 752 (or semi-porous material) to form a retentate 730 comprising a self-standing electrode of a desired thickness and/or density on the porous material at operation 774. The formed self-standing electrode comprises, consists of, or consists essentially of the nanotubes, electrode active material, and the conductive material. The self-standing electrode formed can be those self-standing electrodes described herein such as self-standing electrode 120, 260, 261, 608, as well as the retentate 730 (comprising, consisting of, or consisting essentially of a self-standing electrode), among others. Retentate 730 can also refer to self-standing electrode 730. Porous and semi-porous materials are described herein such as substrates described herein. Other materials and substrates are contemplated.

The filtering process of operation 774 can include introducing the suspended/dispersed nanotubes, suspended/dispersed electrode active material, suspended/dispersed conductive metal, or combinations thereof to a pressure controlled system (e.g., apparatus 700) comprising a porous material 752 (e.g., a porous substrate) and a container 701. The filtering process of operation 774 can also include applying a pressure differential across the porous material 752 to draw the liquid of the suspension(s)/dispersion(s) through the porous material 752 and to the container 701 to form a filtrate 720 disposed within the container 701 and a retentate 730 disposed above the porous material 752.

The filtering process of operation 774 can optionally include washing the retentate 730 with a liquid medium (e.g., a solvent) that does not completely dissolve the nanotubes, electrode active material, and conductive material. Optionally, the retentate 730 comprising the self-standing electrode can be treated at operation 776 to, for example, increase the density of the self-standing electrode, decrease the thickness of the self-standing electrode, or both. The self-standing electrode can be self-supported, flexible, and can optionally be cut to the desired dimensions of a battery electrode. The self-standing electrode is optionally free of binder and optionally can be used without a metal-based current collector. In some aspects, the method 770 can further include removing the retentate 730 comprising self-standing electrode from the porous material 752 at operation 778. Operation 776 can be performed prior to and/or after operation 778.

Aspects of the present disclosure also relate to methods of making a self-standing electrode by a suspension- or dispersion-based process. FIG. 7C is a flowchart showing selected operations of a method 780 of making a self-standing electrode according to at least one aspect of the present disclosure. Method 780 is an illustrative, but non-limiting, method that can be utilized with apparatus 700. Method 780 can be performed when the conductive material 707 is in the form of a mesh, a wire, a strip, a foil, a sponge, a foam, or other suitable structures. The conductive material 707 forms at least a portion of the conductive material of the self-standing electrode. Here, the conductive material 707 (in the form of a mesh, a wire, a strip, a foil, a sponge, a foam, or other suitable structure) can be positioned on the porous material 752.

Method 780 includes suspending or dispersing nanotubes and electrode active material at operation 782. Nanotubes and electrode active material include those nanotubes and electrode active material described herein, among others. In some aspects, the nanotubes and electrode active material can be in the same suspension/dispersion or different suspensions/dispersions. Materials useful to solubilize or suspend the nanotubes and/or electrode active material include, but are not limited to, those materials described above. In method 780, the amount of a component (a conductive metal, nanotubes, an electrode active material, or combinations thereof) used to form a self-standing electrode may be determined by an electrical conductivity percolation point of the component.

Method 780 further includes filtering the suspended/dispersed nanotubes, suspended/dispersed electrode active material, or combinations thereof with a porous (or semi-porous) material, the porous material 752 having a conductive material (the conductive material 707) disposed thereon, to form a retentate comprising a self-standing electrode of a desired thickness and/or density at operation 784. The formed self-standing electrode comprises, consists of, or consists essentially of the nanotubes, electrode active material, and the conductive material 707. The self-standing electrode formed can be those self-standing electrodes described herein such as self-standing electrode 120, 260, 261, 608, as well as the retentate 730 (comprising, consisting of, or consisting essentially of a self-standing electrode), among others. Porous and semi-porous materials are described herein such as substrates described herein. Other materials and substrates are contemplated. Conductive materials for the conductive material 707 include those conductive metals and other conductive materials such as alloys described herein, among others, such as Cu, Al, Ni, Pt, Zn, Ti, stainless steel, sintered carbon, or combinations thereof.

The filtering process of operation 784 can include introducing the suspended/dispersed nanotubes, suspended/dispersed electrode active material, and combinations thereof to a pressure controlled system (e.g., apparatus 700) comprising a porous material 752 (e.g., a porous substrate) and a container 701. Positioned on or above the porous material is the conductive material 707. The filtering process of operation 774 can also include applying a pressure differential across the porous material 752 to draw the liquid of the suspension(s)/dispersion(s) through the porous material 752 and to the container 701 to form a filtrate 720 disposed within the container 701 and a retentate 730 disposed above the porous material 752.

The filtering process of operation 784 can optionally include washing the retentate 730 with a liquid medium (e.g., a solvent) that does not completely dissolve the self-standing electrodes or components thereof. Optionally, the retentate 730 comprising the self-standing electrode can be treated at operation 786 to, for example, increase the density of the self-standing electrode, decrease the thickness of the self-standing electrode, or both. The self-standing electrode can be self-supported, flexible, and can optionally be cut to the desired dimensions of a battery electrode. The self-standing electrode is optionally free of binder and optionally can be used without a metal-based current collector. In some aspects, the method 780 can further include removing the retentate 730 comprising self-standing electrode from the porous material 752 at operation 788. Operation 786 can be performed prior to and/or after operation 788.

Aspects of the present disclosure also generally relate to self-standing electrodes. Aspects of the methods and apparatus described herein can be used to make such self-standing electrodes. Illustrative, but non-limiting, examples of self-standing electrodes 120, 260, 261, 608, 730 formed by aspects of the present disclosure are shown in FIGS. 1B, 2, 6, and 7. The conductive metal of the self-standing electrode can be in the form of a mesh, a wire, a strip, a foil, a sponge, a foam, particles, a powder, or other suitable structures. Self-standing electrodes described herein (for example, self-standing electrode 120, 260, 261, 608, 730) can be free of a binder material. Self-standing electrodes described herein (for example, self-standing electrode 120, 260, 261, 608, 730) can be free of a separate current conductor layer.

Self-standing electrodes described herein (for example, self-standing electrode 120, 260, 261, 608, 730) can have an improved balance of, for example, energy density and electrical conductivity relative to conventional electrodes. In certain aspects, the conductive metal (or conductive material) of the self-standing electrode can be in the form of, for example, particles, powder, mesh, wire, strips, foils, sponge, foam, or other suitable structures. The conductive metal of the self-standing electrode can be embedded, dispersed, or otherwise incorporated in the electrode active material of the self-standing electrode, the nanotubes of the self-standing electrode, or both. Although the inclusion of the conductive metal in the self-standing electrode can increase the weight of the electrode (and can reduce the energy density of the electrode) relative to electrodes that are free of current collectors, the self-standing electrode has significantly higher electrical conductivity relative to electrodes that are free of current collectors. Relative to conventional electrodes having current collectors (e.g., in the form of Cu or Al foils), self-standing electrodes of the present disclosure have improved energy density. As further described below, the amount of conductive metal used in—and therefore the energy density of—self-standing electrodes described herein can be adjusted by, for example, the electrical conductivity percolation point.

At least a portion of self-standing electrodes described herein (for example, self-standing electrode 120, 260, 261, 608, 730) can be in the form of a webbed morphology or a net. In some embodiments, a webbed morphology or a net is a webbed arrangement of nanotubes with electrode active material and/or conductive metal dispersed, contained, or embedded within the nanotube web or net. Although aspects of the self-standing electrode may only be described in relation to self-standing electrode 120, such aspects can apply to other self-standing electrodes described herein such as self-standing electrode 260, 261, 608, 730.

A thickness of the self-standing electrode 120 can be about 1,500 μm or less following collection on the substrate and prior to pressing the self-standing electrode, such as about 1,200 μm or less, such as about 1,000 μm or less, such as about 800 μm or less, such as about 600 μm or less, such as about 500 μm or less, such as about 400 μm or less, such as about 300 μm or less, such as about 200 μm or less, such as about 100 μm or less, or from about 50 μm to about 500 μm, such as from about 100 μm to about 450 μm, such as from about 150 μm to about 300 μm. Any of the foregoing numbers can be used singly to describe an open-ended range or in combination to describe a close-ended range. Other thicknesses are contemplated.

After pressing the self-standing electrode 120, the thickness of the self-standing electrode 120 can be about 300 μm or less, such as from about 20 μm to about 300 μm, such as from about 50 μm to about 250 μm, such as from about 100 μm to about 200 μm, or from about 150 μm to about 300 μm, such as from about 175 μm to about 250 μm. Any of the foregoing numbers can be used singly to describe an open-ended range or in combination to describe a close-ended range. Other thicknesses are contemplated.

The thickness of the self-standing electrode can be adjusted based on the resistance to current or mechanical strength desired.

The combined wt % of the electrode active material(s), the nanotubes, and the conductive metal(s) in self-standing electrodes described herein does not exceed 100 wt %.

A total amount of electrode active material in a self-standing electrode described herein can be from about 50 wt % to about 90 wt %, such as from about 60 wt % to about 80 wt %, such as from about 65 wt % to about 75 wt %, based on the total weight of the electrode active material(s), the nanotubes, and the conductive metal(s). In some aspects, a total amount (in wt %) of the electrode active material in a self-standing electrode, based on the total weight of the electrode active material, the nanotubes, and the conductive metal(s) in the self-standing electrode, can be 50, 55, 60, 65, 70, 75, 80, 85, or 90, or ranges thereof, though higher or lower amounts are contemplated. Each of the foregoing numbers can be preceded by the word “about,” “at least about,” “less than about,” or “more than about,” and any of the foregoing numbers can be used singly to describe an open-ended range or in combination to describe a close-ended range.

A total amount of nanotubes in a self-standing electrode described herein can be from about 0.5 wt % to about 15 wt %, such as from about 1 wt % to about 12.5 wt %, such as from about 2 wt % to about 10 wt %, such as from about 3 wt % to about 8 wt %, such as from about 4 wt % to about 5 wt %, based on the total weight of the electrode active material(s), the nanotubes, and the conductive metal(s). In some aspects, a total amount of nanotubes in a self-standing electrode described herein can be from about 0.5 wt % to about 5 wt %, such as from about 1 wt % to about 4.5 wt %, such as from about 1.5 wt % to about 4 wt %, such as from about 2 wt % to about 3.5 wt %, such as from about 2.5 wt % to about 3 wt % based on the total weight of the electrode active material(s), the nanotubes, and the conductive metal(s). In at least one aspect, a total amount (in wt %) of the nanotubes in a self-standing electrode, based on the total weight of the electrode active material, the nanotubes, and the conductive metal(s) in the self-standing electrode, can be 0.5, 1, 1.5, 2, 2.5, 3, 3.5, 4, 4.5, 5, 5.5, 6, 6.5, 7, 7.5, 8, 8.5, 9, 9.5, 10, 10.5, 11, 11.5, 12, 12.5, 13, 13.5, 14, 14.5, or 15, or ranges thereof, though higher or lower amounts are contemplated. Each of the foregoing numbers can be preceded by the word “about,” “at least about,” “less than about,” or “more than about,” and any of the foregoing numbers can be used singly to describe an open-ended range or in combination to describe a close-ended range.

A total amount of conductive metal(s) in a self-standing electrode described herein described herein can be from about 3 wt % to about 50 wt %, such as from about 10 wt % to about 40 wt %, such as from about 15 wt % to about 35 wt %, such as from about 20 wt % to about 30 wt %, based on the total weight of the electrode active material(s), the nanotubes, and the conductive metal(s). In some aspects, a total amount (in wt %) of the conductive metal(s) in a self-standing electrode, based on the total weight of the electrode active material, the nanotubes, and the conductive metal(s) in the self-standing electrode, can be 3, 4, 5, 6, 7, 8, 9, 10, 11, 12, 13, 14, 15, 16, 17, 18, 19, 20, 21, 22, 23, 24, 25, 26, 27, 28, 29, 30, 31, 32, 33, 34, 35, 36, 37, 38, 39, or 40, or ranges thereof, though higher or lower amounts are contemplated. Each of the foregoing numbers can be preceded by the word “about,” “at least about,” “less than about,” or “more than about,” and any of the foregoing numbers can be used singly to describe an open-ended range or in combination to describe a close-ended range.

The amount of conductive material utilized can depend on the shape of the conductive material. For example, and in some non-limiting aspects, a spherical-shaped powder of conductive material can be used at concentrations of up to about 50 wt %. As another non-limiting example, and in some aspects, when the conductive metal is a rod-shaped powder having an aspect ratio (L/D) of about 10, the amount of conductive material used can be as low as about 3 wt % such as from about 3 wt % to about 15 wt %, such as from about 3 wt % to about 5 wt %.

An aspect ratio of the conductive material (e.g., conductive metal) in a self-standing electrode described herein described herein can depend on the shape of the particles/powders of the conductive material. When the conductive material is spherical or substantially spherical, the aspect ratio (L/D) of length (L) to diameter (D) can be about 1. When the conductive material is, for example, rod-shaped (L>D), the aspect ratio (L/D) can be from about 10 to about 100, such as from about 20 to about 90, such as from about 30 to about 80, such as from about 40 to about 70, such as from about 50 to about 60. In some examples, the conductive material can have an aspect ratio of about 1,000 to about 100,000. Any of the foregoing numbers can be used singly to describe an open-ended range or in combination to describe a close-ended range. Other aspect ratios are contemplated.

Any suitable shape of conductive material can be utilized such as spherical, rod-shaped, among other shapes.

In an illustrative, but non-limiting, example, a self-standing electrode described herein (such as self-standing electrode 120) can have a density that is about 1 g/cc or more, 6 g/cc or less, or combinations thereof. The density of the self-standing electrode can depend on the amount of conductive material present in the self-standing electrode. For example, when the self-standing electrode includes about 50 wt % of conductive material (e.g., conductive metal), the density of the self-standing electrode after treating (e.g., pressing) can be about 5 g/cc to about 6 g/cc. As another example, when the self-standing electrode includes about 10 wt % of conductive material (e.g., conductive metal), the density of the self-standing electrode after treating (e.g., pressing) can be about 3 g/cc to about 4 g/cc. After treating (e.g., pressing), and in some aspects, the self-standing electrode can have a density that is from about 1.5 g/cc to about 6 g/cc, such as from about 2 g/cc to about 5.5 g/cc, such as from about 2.5 to about 5 g/cc, such as from about 3 g/cc to about 4 g/cc. Any of the foregoing numbers can be used singly to describe an open-ended range or in combination to describe a close-ended range. Other densities are contemplated.

In some non-limiting but illustrative aspects, a self-standing electrode described herein can have an electrical conductivity (in units of siemens per meter, S/m) that is about 9×10⁶ S/m or less, 30 S/m or more, or combinations thereof. In some examples, a self-standing electrode described herein can have an electrical conductivity that is from about 30 S/m to about 1,000 S/m or from about 1×10⁴ S/m to about 9×10⁶ S/m. Any of the foregoing numbers can be used singly to describe an open-ended range or in combination to describe a close-ended range. Other thicknesses are contemplated.

In some aspects, a self-standing electrode described herein includes electrode active material(s), nanotubes, and conductive metal(s). The self-standing electrode can be free of a binder material. In some aspects the self-standing electrode described herein includes a composite comprising electrode active material(s), nanotubes, and conductive metal(s).

The conductive metal (or conductive material) of a self-standing electrode described herein can be in the form of an article such as a woven or a non-woven article of the self-standing electrode. The woven and non-woven article described herein, such as textiles, fabrics, sheets, webs, films, mats, aggregates, or other structures can be formed or patterned from a fiber, yarn, cable, wire, thread, or similar structures, where the fiber, yarn, cable, wire, thread, or similar structures includes the conductive metal (or conductive material).

As used herein, the terms “fiber,” “yarn,” “cable,” “wire,” and “thread” are used interchangeably unless specified to the contrary or the context clearly indicates otherwise. Accordingly, use of the term “fiber” herein is intended to include fiber, yarn, cable, wire, thread, or a similar structure unless specified to the contrary or the context clearly indicates otherwise. As used herein, the terms “textile,” “fabric,” “sheet,” “web,” “film,” “mat,” and “aggregate,” are used interchangeably unless specified to the contrary or the context clearly indicates otherwise. Accordingly, use of the term “textile” herein is intended to include textile, fabric, sheet, web, film, mat, aggregate, or a similar structure unless specified to the contrary or the context clearly indicates otherwise.

Briefly, a fiber described herein can include a conductive metal. A plurality of such fibers can be weaved, interweaved, intertwined, entwined, knitted, merged, twisted, tangled, stitched, molded, or otherwise united together in the form of a woven or non-woven article such as a textile. The woven or non-woven article can be utilized as an electrically conductive portion of the self-standing electrode. The conductive metal can, individually, be in the form of a wire, a yarn, a cable, fiber, thread, or a similar structure. In some aspects, at least two conductive metals (or alloys) can be formed into a wire, a yarn, a cable, a fiber, or similar structures by coupling two or more of the conductive metals. As described above and in some aspects, the self-standing electrode can include the (conductive metal or conductive material) in the form of a mesh, a wire, a strip, a foil, a sponge, a foam, a powder, a particle, or other suitable structures.

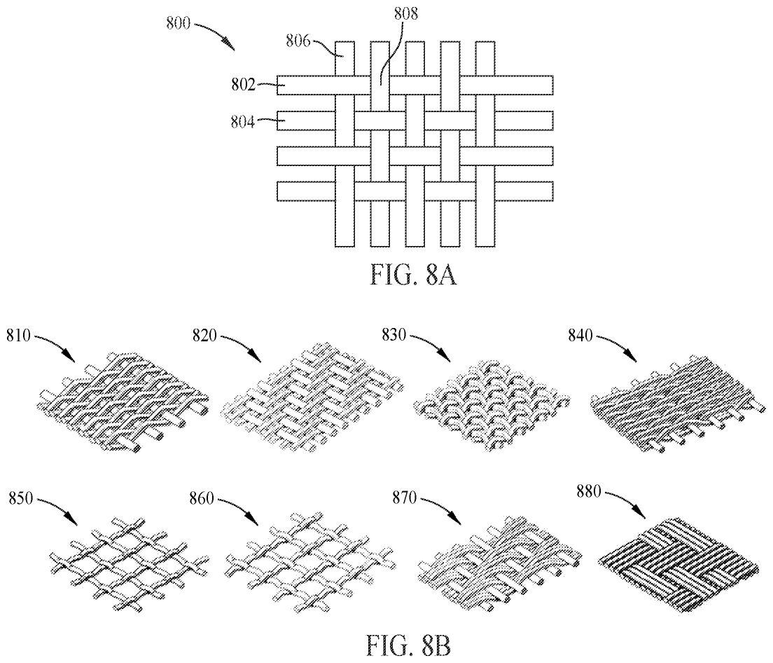

FIG. 8A is an illustration of a textile 800 that can be used as, for example, at least a portion of a self-standing electrode described herein, such as at least a portion of self-standing electrodes described herein (for example, self-standing electrode 120, 260, 261, 608, 730) according to at least one aspect of the present disclosure. Although aspects of the self-standing electrode incorporating a textile 800 may only be described in relation to self-standing electrode 120, such aspects can apply to other self-standing electrodes described herein such as self-standing electrode 260, 261, 608, 730.

The textile 800 includes a plurality of fibers. In some aspects, a first fiber 802 (or plurality of first fibers) can include a first conductive metal and a second fiber 804 (or plurality of second fibers) can include a second conductive metal. The textile 800 can also include a third fiber 806 (or plurality of third fibers) that can include a third conductive metal. The first, second, and third conductive metals can be the same or different.

The conductive material (for example, conductive metal, conductive metal alloy, other conductive material, or combinations thereof) can include copper, aluminum, nickel, platinum, zinc, titanium, stainless steel, sintered carbon, or combinations thereof, among other materials. In some aspects, a self-standing electrode useful as an anode (for example, self-standing electrode 120) can include copper as a conductive metal. In some aspects, a self-standing electrode useful as a cathode (for example, self-standing electrode 120) can include aluminum as a conductive metal.

In some implementations, the first fiber 802 and second fiber 804 can correspond to different horizontal fibers of the textile 800 formed from a single fiber. In at least one implementation, the first fiber 802 and the second fiber 804 can correspond to distinct fibers. The vertical fibers (for example, third fiber 806) can include a conductive material (for example, a conductive metal, a conductive metal alloy, other conductive material, or combinations thereof). As illustrated, the third fiber 806 can correspond to a wire that is made of, or includes, the conductive material. In some implementations, the third fiber 806 can correspond to different vertical fibers of the textile 800 formed from a single fiber. In at least one implementation, third fiber 806 can correspond to distinct fibers.

In some aspects, one or more first fibers 802, one or more second fibers 804, one or more third fibers 806, or combinations thereof, can be weaved, interweaved, intertwined, entwined, knitted, merged, twisted, tangled, or otherwise united together to form the article such as textile 800. One or more first fibers 802, one or more second fibers 804, or combinations thereof, may be coupled to or substantially coupled to (for example, attached to, substantially attached to, contacting, or nearly contacting) one or more third fibers 806 at one or more coupling points 808. Only one coupling point 808 is identified for clarity. In some aspects, coupling may be performed by weaving, welding (for example, laser welding), adhesive (for example, with a cyanoacrylate adhesive or an epoxy-based adhesive), or combinations thereof. In some aspects which can be combined with other aspects, individual fibers (tubes) can be attached to each other by Van der Waals interactions and can be in the form of bundles. Bundles may be attached to other bundles and/or other fibers by mechanical reinforcement depending on the weaving or knitting style.

In some aspects, vertical fibers (for example, third fiber 806) may pass over and/or under a single fiber or a group of fibers. For example, the third fiber 806 can pass over or under a single first fiber 802 or a plurality of first fibers 802 before passing over and/or under a single second fiber 804 or a plurality of second fibers 804. In the example illustrated in FIG. 8A, the third fiber 806 passes under a portion of the first fiber 802 then passes over a portion of the second fiber 804. A vertical fiber (not labeled) adjacent to third fiber 806 first passes over a portion of the first fiber 802 then passes under a portion of the second fiber 804. In other examples, vertical fibers (for example, third fiber 806) may alternate between passing over and under the horizontal fibers (for example, first fiber 802 and second fiber 804) and at different intervals. In the illustrated example, the third fiber 806 is coupled to (for example, attached to, contacting, or nearly contacting) the first fiber 802 and the second fiber 804. In some aspects, vertical fibers (for example, third fiber 806) may be coupled to (for example, attached to, contacting, or nearly contacting) some but not all horizontal fibers (for example, the first fiber 802 and the second fiber 804). For example, a particular vertical fiber may be attached to every second, third, fourth, fifth, sixth, seventh, eighth, ninth, tenth, and so forth, horizontal fiber.

In at least one aspect, adjacent vertical fibers may pass to the same side of horizontal fibers. For example, the third fiber 806 can pass over the first fiber 802 and the second fiber 804. In other implementations, adjacent vertical fibers may traverse a common horizontal fiber differently (for example, one vertical fiber may pass over the common horizontal fiber while the other passes under the common horizontal fiber). In some examples, adjacent vertical fibers are separated and/or in contact with each other. In at least one example, adjacent horizontal fibers are separated and/or in contact with each other. Various weaving configurations are discussed below and shown in FIG. 8B.

In some aspects, at least two of the fibers described herein can be used to form a non-woven textile, such as a non-woven textile where the fibers are randomly tangled with one another.

FIG. 8B shows various weaving configurations or patterns that can be used for the textiles described herein, for example, textile 800. The various weaving configurations can enable, for example, control over porosity and/or density of the textiles. Illustrative, but non-limiting, examples of configurations can include a plain Dutch weave 810, a twill weave 820, a plain weave 830, a twill Dutch weave 840, a lock crimp weave 850, an inter-crimp weave 860, a twill Dutch double weave 870, a stranded weave 880, or combinations thereof. Other weave configurations or patterns are contemplated.

With respect to plain weaves, a horizontal fiber runs perpendicular to a vertical fiber. The gaps between the fibers can be square, substantially square, rectangular, or substantially rectangular depending on the proximity of each horizontal fiber is to neighboring fibers. Twill weaves typically have fibers running over and under adjacent fibers in multiples. A basic twill weave may have a horizontal fiber running over then under two vertical fibers at a time with the first double offset by one vertical fiber at the beginning of each pass. Twill weaves can additionally, or alternatively, include more complex patterns as desired.

Dutch weaves and stranded weaves, are also contemplated. Dutch weaves and stranded weaves can have a tighter mesh than the other weave configurations. Dutch weaves can have the vertical fibers with a larger diameter than the horizontal fibers. The larger diameter vertical fibers can enable the horizontal fibers to compress more closely. With respect to stranded weaves, several strands of fibers comprise each length of vertical fiber and horizontal fiber.

The horizontal fibers described herein can be weft fibers or warp fibers; the vertical fibers described herein can be weft fibers or warp fibers. Typically, the lengthwise or longitudinal warp fibers are held stationary in tension on a frame or loom while the transverse weft fibers are drawn through and inserted over and/or under the warp fibers.

One or more of the individual fibers used to form the configurations or patterns of at least a portion of textile 800 include conductive metal(s)/metal alloy(s)/material(s). Additionally, or alternatively, particle(s) comprising conductive metal(s)/metal alloy(s)/material(s) can be disposed on, deposited on, embedded in, dispersed on or in, or otherwise on or in a surface, a pore, or other facet/structure of the one or more fibers.

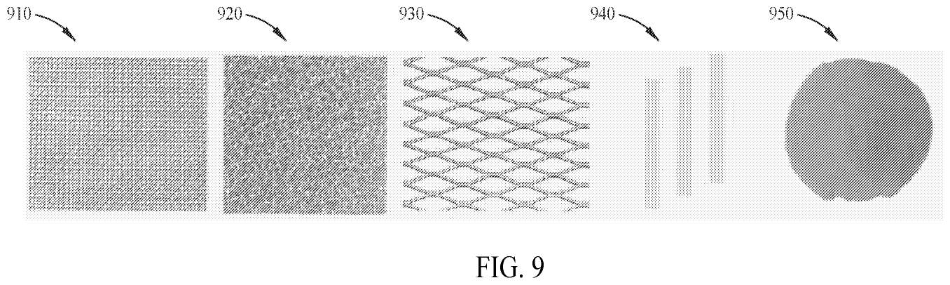

FIG. 9 shows illustrative, but non-limiting, examples of the structures for the conductive material of self-standing electrodes described herein according to at least one aspect of the present disclosure. Such structures include a woven structure 910 (or woven-like structure), a sponge 920 (or sponge-like structure), a mesh 930 (or mesh-like structure), a wire 940 (or wire-like structure), and a powder 950 (or powder-like structure). Other structures include a foil, a foam, a particle, among others. One or more of structures 910, 920, 930, 940, 950 of the conductive material can be incorporated into a self-standing electrode described herein, such as self-standing electrode 120, 260, 261, 608, 730. In some aspects, at least a portion of the conductive material in a self-standing electrode is in the form of structure 910, structure 920, structure 930, structure 940, structure 950, or combinations thereof.

Any apparatus and/or method described herein can be combined with other apparatus and/or methods described herein to form self-standing electrodes, such as those self-standing electrodes described herein.

In some aspects, a self-standing electrode described herein, such as self-standing electrode 120, 260, 261, 608, 730 includes a composite material that includes an electrode active material, nanotubes, and a conductive metal.

The self-standing electrodes described herein can be used as an anode or a cathode depending on, for example, the conductive metal of the self-standing electrode.

Aspects described herein also generally relate to energy storage devices such as batteries. Conventional electrodes for lithium-ion batteries include current collectors and binder materials that increase the weight of the electrodes and decrease the specific energy density of the electrodes. To increase the specific energy density of the electrodes, self-standing electrodes that are free of both the current collector and binder have been developed such as those described in U.S. Patent Application Publication Nos. 2019/0036103 and 2020/0259160 and U.S. patent application Ser. Nos. 15/665,171 and 16/845,524, each of which is incorporated herein by reference in their entireties. However, the electrical conductivity of such self-standing electrodes can be lower relative to those having Cu or Al current collector foils. The decreased electrical conductivity can limit the usage of such self-standing electrodes in batteries where, for example, fast-charging applications are desired. As described herein, the inventor has found that collector foils (having conductive metals such as Cu, Al, and/or other conductive metals) of conventional lithium-ion electrodes or other suitable energy storage devices can be replaced by utilizing a self-standing electrode that includes the conductive metal (or conductive material) in the form of, for example, particles, powder, mesh, wire, strips, foils, sponge, foam, or other suitable structures. The conductive metal (or conductive material) of the self-standing electrode can be embedded, dispersed, or otherwise incorporated in the electrode active material of the self-standing electrode, the nanotubes of the self-standing electrode, or both. Alternatively, the conductive metal (or conductive material) can be in a layer that is separate from the nanotubes and the electrode active material. In such configurations, the self-standing electrodes described herein can have an improved balance of electrical conductivity and specific energy density relative to conventional electrodes and self-standing electrodes.

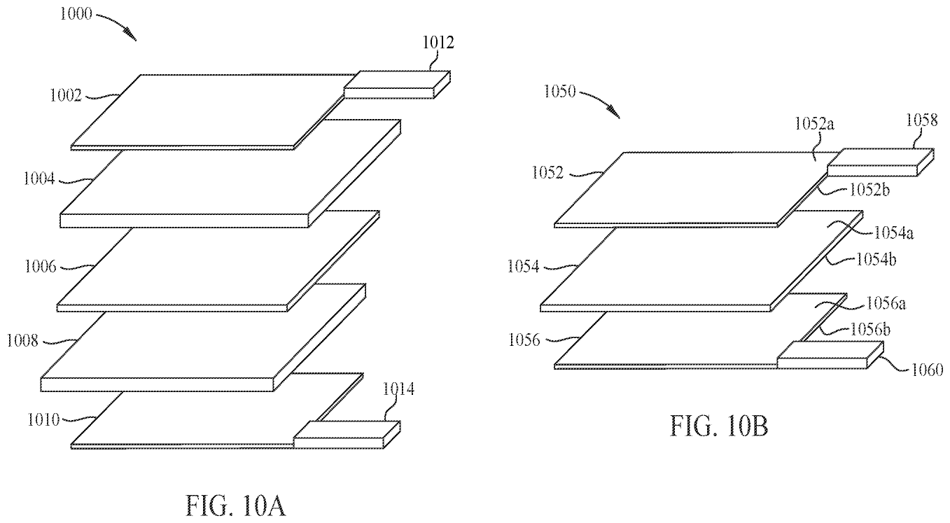

FIG. 10A is an exploded perspective view of a conventional lithium-ion battery 1000. The conventional lithium-ion battery 1000 includes an anode current collector 1002 (for example, Cu foil), a slurry layer 1004 of anode active material (for example, graphite, carbon black, and binder), a separator 1006, a slurry layer 1008 of cathode active material (for example, LiMeOₓ, carbon black, and binder), a cathode current collector 1010 (for example, Al foil). Packaging layers (not shown) may be located on a surface of the anode current collector 1002 and a surface of the cathode current collector 1010. The conventional lithium-ion battery 1000 also includes tabs 1012, 1014 that carry the positive and negative current from the electrodes.

FIG. 10B is an exploded perspective view of an example of a battery 1050 according to at least one aspect of the present disclosure. The embodiment of the battery 1050 shown in FIG. 10B is for illustrative purposes only and is non-limiting. The battery 1050 can be a lithium-ion battery or a sodium-ion battery. In some aspects, the battery 1050 can be a secondary battery or a rechargeable battery. The battery 1050 can have any suitable configuration such as a half-cell type, a coin type, a button type, a cylindrical type, flat-plate type, an all solid type, or a spirally wound type, though other configurations are contemplated. Relative to conventional batteries incorporating current collectors and binder materials, the batteries described herein can have a higher specific energy density. Moreover, the batteries described herein can have higher electrical conductivity relative to those batteries incorporating self-standing electrodes that are free of both the current collector and binder.

The battery 1050 includes an anode 1052 having a top surface 1052a and a bottom surface 1052b, a separator 1054 having a top surface 1054a and a bottom surface 1054b, and a cathode 1056 having a top surface 1056a and a bottom surface 1056b. Self-standing electrodes described herein can be used for the anode 1052. For example, the anode 1052 can include an electrode (anode) active material, nanotubes, a conductive metal (or conductive material), or combinations thereof. In some examples, the electrode active material of the anode 1052 can include, for example, graphite, silicon, a porous material that matches or substantially matches the potential of the given cathode material, natural graphite, artificial graphite, activated carbon, carbon black, high-performance powdered graphene, among others, and combinations thereof, such as Si, SiOx/C, graphite, or combinations thereof. The nanotubes of the anode 1052 can be, for example, carbon nanotubes in the form of a three-dimensional cross-linked network. According to some aspects, the three-dimensional cross-linked network of carbon nanotubes can have a webbed morphology, a non-woven, non-regular, or non-systematic morphology, or combinations thereof. As described herein, the conductive metal (or conductive material) of the anode 1052 can include Cu and/or another conductive metal/material. As also described herein, the conductive metal (or conductive material) of the anode 1052 can be in the form of, for example, particles, powder, mesh, wire, strips, foils, sponge, foam, or other suitable structures. The conductive metal (or conductive material) of the anode 1052 can be embedded, dispersed, or otherwise incorporated in the electrode active material, the nanotubes, or both the electrode active material and the nanotubes of the anode 1052. Additionally, or alternatively, conductive metal (or conductive material) of the anode 1052 can be in a layer that is separate from the nanotubes of the anode 1052 and/or the electrode active material of the anode 1052.

Self-standing electrodes described herein can be used for the cathode 1056. For example, the cathode 1056 can include an electrode (cathode) active material, nanotubes, a conductive metal (or conductive material), or combinations thereof. In some examples, the electrode active material of the cathode 1056 can include, for example, lithium metal oxide, lithium metal, among others, or combinations thereof in the form of, for example, particles. The nanotubes of the cathode 1056 can be, for example, carbon nanotubes in the form of a three-dimensional cross-linked network of carbon nanotubes. According to some aspects, the three-dimensional cross-linked network of carbon nanotubes can have a webbed morphology, a non-woven, non-regular, or non-systematic morphology, or combinations thereof. As described herein, the conductive metal (or conductive material) of the cathode 1056 can include Al and/or another conductive metal/material. As also described herein, the conductive metal (or conductive material) of the cathode 1056 can be in the form of, for example, particles, powder, mesh, wire, strips, foils, sponge, foam, or other suitable structures. The conductive metal (or conductive material) of the cathode 1056 can be embedded, dispersed, or otherwise incorporated in the electrode active material, the nanotubes, or both the electrode active material and the nanotubes of the cathode 1056. Additionally, or alternatively, conductive metal (or conductive material) of the cathode 1056 can be in a layer that is separate from the nanotubes of the cathode 1056 and/or the electrode active material of the cathode 1056.

In some aspects, metals in lithium metal oxides of the cathode 1056 according to the present disclosure may include, but are not limited to, one or more alkali metals, alkaline earth metals, transition metals, aluminum, or post-transition metals, and hydrates thereof. Non-limiting examples of lithium metal oxides include lithiated oxides of Ni, Mn, Co, Al, Mg, Ti, alloys thereof, or combinations thereof. In an illustrative example, the lithium metal oxide is lithium nickel manganese cobalt oxide (LiNiₓMn_{y}Co_{z}O₂, x+y+z=1), Li(Ni,Mn,Co)O₂, or Li—Ni—Mn—Co—O. The lithium metal oxide can be in the form of a powder. The lithium metal oxide powder can have a particle size defined within a range between about 1 nanometer (nm) and about 100 microns (μm), or any integer or subrange in between. In a non-limiting example, the lithium metal oxide particles have an average particle size of about 1 μm to about 10 μm. In some aspects, an active material for the cathode 1056 can include LiFePO₄, LiCoO₂, Li—Ni—Mn—Co—O, or combinations thereof. Other materials for the cathode 1056 are contemplated.

The separator 1054 is positioned between the anode 1052 and the cathode 1056. For example, the bottom surface 1052b of the anode 1052 is disposed on or over at least a portion of the top surface 1054a of the separator 1054, and the bottom surface 1054b of the separator 1054 is disposed on or over the top surface 1056a of the cathode 1056. Various separators can be used with aspects described herein. The separator 1054 can be single ply or multi-ply. The separator 1054 can include at least one layer composed of or including one or more polymers. Suitable materials useful for the separator 1054 include those known to persons of ordinary skill in the art for use in between battery anodes and cathodes, to provide a barrier between the anode and the cathode while enabling the exchange of lithium ions from one side to the other, such as a membranous barrier or a separator membrane. The separator membrane can be permeable to lithium ions, allowing them to travel from the cathode side to the anode side and back during the charge-discharge cycle. The separator membrane can be impermeable to anode and cathode materials, preventing them from mixing, touching, and shorting the battery. The separator membrane can also serve as an electrical insulator for metal parts of the battery (leads, tabs, metal parts of the enclosure, among others) preventing them from touching and shorting. Illustrative, but non-limiting, examples of suitable materials that can be used the one or more polymers of the separator 215 include polyolefins such as polypropylene, polyethylene, polyimidazoles, polybenzimidazole (PBI), polyimides, polyamideimides, polyaramids, polysulfones, polyvinylidene fluoride, aromatic polyesters, polyketones, polytetrafluoroethylene (PTFE), blends thereof, mixtures thereof, and combinations thereof. Commercial polymer separators include, for example, the Celgard™ line of separators.

In some aspects, the separator 1054 is a thin (about 15-25 μm) polymer membrane (tri-layer composite: polypropylene-polyethylene-polypropylene, commercially available) between two relatively thick (about 20-1000 μm) porous electrode sheets. The thin polymer membrane may be about 15-25 μm thick, such as 15-23, 15-21, 15-20, 15-18, 15-16, 16-25, 16-23, 16-21, 16-20, 16-18, 18-25, 18-23, 18-21, 18-20, 20-25, 20-23, 20-21, 21-25, 21-23, 23-25, 15, 16, 17, 18, 19, 20, 21, 22, 23, 24, or 25 μm thick, or any integer or subrange in between. The two relatively thick porous electrode sheets may each independently be 50-500 μm thick, such as 50-450 μm, 50-400 μm, 50-350 μm, 50-300 μm, 50-250 μm, 50-200 μm, 50-150 μm, 50-100 μm, 50-75 μm, 50-60 μm, 50-55 μm, 55-500 μm, 55-450 μm, 55-400 μm, 55-350 μm, 55-300 μm, 55-250 μm, 55-200 μm, 55-150 μm, 55-100 μm, 55-75 μm, 55-60 μm, 60-500 μm, 60-450 μm, 60-400 μm, 60-350 μm, 60-300 μm, 60-250 μm, 60-200 μm, 60-150 μm, 60-100 μm, 60-75 μm, 75-500 μm, 75-450 μm, 75-400 μm, 75-350 μm, 75-300 μm, 75-250 μm, 75-200 μm, 75-150 μm, 75-100 μm, 100-500 μm, 100-450 μm, 100-400 μm, 100-350 μm, 100-300 μm, 100-250 μm, 100-200 μm, 100-150 μm, 150-500 μm, 150-450 μm, 150-400 μm, 150-350 μm, 150-300 μm, 150-250 μm, 150-200 μm, 200-500 μm, 200-450 μm, 200-400 μm, 200-350 μm, 200-300 μm, 200-250 μm, 250-500 μm, 250-450 μm, 250-400 μm, 250-350 μm, 250-300 μm, 300-500 μm, 300-450 μm, 300-400 μm, 300-350 μm, 350-500 μm, 350-450 μm, 350-400 μm, 400-500 μm, 400-450 μm, 450-500 μm, 50 μm, 55 μm, 60 μm, 75 μm, 100 μm, 150 μm, 200 μm, 250 μm, 300 μm, 350 μm, 400 μm, 450 μm, or 500 μm, or any integer or subrange in between. Other dimensions and materials for the separator 1054 are contemplated.

Optionally, the battery 1050 can further include a first tab 1058 (also known as a lead) contacting a surface of the anode 1052 and a second tab 1060 (also known as a lead) contacting a surface of the cathode 1056. The first tab 1058 can be soldered or fused to the anode 1052, and the second tab 235 can be soldered or fused to the cathode 1056. Soldering or fusing of the first tab 1058 to the anode 1052 can be performed via a low-resistance contact formed between the first tab 1058 and conductive component(s) of the anode 1052. Soldering or fusing of the second tab 1060 to the cathode 1056 can be performed in the same manner. Optionally, the battery 1050 can further include one or more packaging layers disposed on one or more surfaces of the anode 852 and/or the cathode 856, for example, the top surface 1052a of the anode 1052 and/or the bottom surface 1056b of the cathode 1056.

Although not shown, the battery 1050 can include one or more electrolytes. Any suitable electrolyte can be used with aspects described herein. In some aspects, the electrolyte can include a liquid electrolyte, a solid electrolyte, a gel electrolyte, a polymer ionic liquid. In at least one aspect, the gel electrolyte can be any suitable gel electrolyte known in the art. For example, the gel electrolyte can include a polymer and a polymer ionic liquid. For example, the polymer can be a solid graft (block) copolymer electrolyte. In some aspects, the solid electrolyte can be, for example, an organic solid electrolyte or an inorganic solid electrolyte. Non-limiting examples of the organic solid electrolyte can include polyethylene derivatives, polyethylene oxide derivatives, polypropylene oxide derivatives, phosphoric acid ester polymer, polyester sulfide, polyvinyl alcohol, polyfluoride vinylidene, and polymers including ionic dissociative groups. A combination comprising at least one of the foregoing can also be used.

When a liquid electrolyte is utilized, the liquid electrolyte can be a non-aqueous liquid electrolyte, aqueous liquid electrolyte, or combinations thereof. The non-aqueous liquid electrolyte can include an electrolyte salt and a non-aqueous solvent. Illustrative, but non-limiting, examples include propylene carbonate, ethylene carbonate, vinylene carbonate, dimethyl carbonate, ethyl methyl carbonate, diethyl carbonate, methyl propyl carbonate, isopropyl methyl carbonate, ethyl propionate, methyl propionate, γ-butyrolactone, ethyl acetate, methyl acetate, tetrahydrofuran, 2-methyltetrahydrofuran, ethylene glycol dimethyl ether, ethylene glycol diethyl ether, acetonitrile, dimethyl sulfoxide, diethoxyethane, 1,1-dimethoxyethane, tetraethylene glycol dimethyl ether, and combinations thereof.

An ionic liquid can be used as the non-aqueous solvent. Examples of ionic liquids can include aliphatic quaternary ammonium salts such as N,N,N-trimethyl-N-propylammonium bis(trifluoromethanesulfonyl)amide, N-methyl-N-propylpiperidinium bis(trifluoromethanesulfonyl)amide, N-methyl-N-propylpyrrolidinium bis(trifluoromethanesulfonyl)amide, N-methyl-N-butylpyrrolidinium bis(trifluoromethanesulfonyl)amide, and N,N-diethyl-N-methyl-N-(2-methoxyethyl)ammonium bis(trifluoromethanesulfonyl)amide; and alkylimidazolium quaternary salts such as 1-methyl-3-ethylimidazolium tetrafluoroborate, 1-methyl-3-ethylimidazolium bis(trifluoromethanesulfonyl)amide, 1-allyl-3-ethylimidazolium bromide, 1-allyl-3-ethylimidazolium tetrafluoroborate, 1-allyl-3-ethylimidazolium bis(trifluoromethanesulfonyl)amide, 1,3-diallylimidazolium bromide, 1,3-diallylimidazolium tetrafluoroborate, 1,3-diallylimidazolium bis(trifluoromethanesulfonyl)amide, and combinations thereof.

The electrolyte salt can be soluble in non-aqueous solvents and able to exhibit desired ion conductivity. For example, a metal salt containing a metal ion desired to be conducted, can be used as the electrolyte salt. For example, lithium salts can be used as the electrolyte salt. For example, lithium salts such as LiPF₆, LiBF₄, LiClO₄, LiAsF₆, LIOH, LiCl, LiNO₃ and Li₂SO₄; and organic lithium salts such as CH₃CO₂Li, lithium bis(oxalate)borate (LiBOB), LiN(CF₃SO₂)₂ (LiTFSA), LiN(C₂F₅SO₂)₂ (LiBETA), and/or LiN(CF₃SO₂)(C₄F₉SO₂) can be utilized.

The content the electrolyte salt relative to the non-aqueous solvent in the non-aqueous liquid electrolyte can be appropriately determined depending on the combination of the solvent and the electrolyte salt. The non-aqueous liquid electrolyte may be used in the form of gel by adding a polymer thereto. Examples of methods for gelation of the non-aqueous liquid electrolyte, include a method of adding a polymer such as polyethylene oxide (PEO), polyacrylonitrile (PAN), polyvinylidene fluoride (PVDF) or polymethyl methacrylate (PMMA) to the non-aqueous liquid electrolyte.

Examples of the aqueous liquid electrolyte can include alkaline aqueous solutions such as potassium hydroxide aqueous solution and/or sodium hydroxide aqueous solution. Examples of the aqueous liquid electrolyte can include acidic aqueous solutions such as hydrochloric acid solution, nitric acid solution, and/or sulfuric acid solution. The aqueous liquid electrolyte can be appropriately selected, depending on, for example, the type of the anode active material.

Solid electrolyte can be utilized. Non-limiting examples of the solid electrolyte include inorganic solid electrolytes such as a solid sulfide electrolyte and/or a solid oxide electrolyte. The inorganic solid electrolyte can be in the form of glass, crystal, and/or glass ceramic. Solid sulfide electrolytes contain sulfur (S) and are ion-conductive. Non-limiting examples of solid sulfide electrolyte materials can include Li₂S—P₂S₅ (Li₂S:P₂S₅=50:50 to 100:0), Li₂S—P₂S₅—LiI, Li₂S—P₂S₅—Li₂O—LiI, Li₂S—SiS₂, Li₂S—SiS₂—LiI, Li₂S—SiS₂—LiBr, Li₂S—SiS₂—LiCl, Li₂S—SiS₂—B₂S₃—LiI, Li₂S—SiS₂—P₂S₅—LiI, Li₂S—B₂S₃, Li₂S—P₂S₅—ZₘSₙ (Z=Ge, Zn, Ga; m is the amount Z; and n is the amount of sulfur), Li₂S—GeS₂, Li₂S—SiS₂—Li₃PO₄, and/or Li₂S—SiS₂—LiₓMO_{y} (M=P, Si, Ge, B, Al, Ga, In; x is the amount Li; and y is the amount of oxygen). Solid oxide electrolytes include LiPON (lithium phosphorus oxynitride), LiAlTi type (for example, Li_{1.3}Al_{0.3} Ti_{0.7}(PO₄)₃), LaLiTi type (for example, La_{0.51}Li_{0.34}TiO_{0.74}), Li₃PO₄, Li₂SiO₂, and/or Li₂SiO₄. Other materials for the electrolyte are contemplated. Combinations of various electrolytes can be used.

Aspects described also generally relate to uses of the self-standing electrodes in batteries and such batteries can be utilized with, or otherwise incorporated into, various devices utilizing batteries such as automobiles, other land vehicles (trucks), trains, aircraft, watercraft, satellite systems. An exemplary, but non-limiting, battery is described in relation to FIG. 10B. In another aspect, an article is provided. The article includes a device and the battery 1050 electrically coupled to the device. The battery 1050 can be electrically coupled by known methods to any suitable device, or one or more components of the device, that is or can be operated by a battery. Illustrative, but non-limiting, examples of such devices can include a land vehicle (e.g., a car, motorcycle, truck, bus, scooter, train, tram), a bicycle, an aircraft (e.g., an airplane, helicopter, aerostat), a watercraft (e.g., a ship, boat, underwater vehicle), an amphibious vehicle (e.g., screw-propelled vehicle, hovercraft), a spacecraft, a satellite, a light emitting diode, a consumer electronic (such as a laptop computer, an antenna, a car radio, a mobile phone, a watch, and a telecommunication base station), a motor, a wind turbine, a bridge, a building, a pipeline, a smart grid, or components thereof. The battery 1050 can be incorporated into various other devices such as storage batteries for power generating units using wind power or sunlight, electric vehicles, uninterruptable power supplies (UPS), and household storage batteries. The battery 1050 can also be used as a unit battery of a medium-large size battery pack or battery module that includes a plurality of battery cells for use as a power source of a medium-large size device. The aforementioned uses are non-limiting and other uses are contemplated.

The following examples are put forth so as to provide those of ordinary skill in the art with a complete disclosure and description of how to make and use aspects of the present disclosure, and are not intended to limit the scope of aspects of the present disclosure. Efforts have been made to ensure accuracy with respect to numbers used (such as the amounts, dimensions) but some experimental errors and deviations should be accounted for.

### EXAMPLES

Electro-mechanical measurements of composite electrodes. The stress-strain characteristics of the electrode materials were measured using testing machine 303 by Mark10 with a 2.5 Newton gauge at 0.1 to 10 mm/sec displacement rates. The samples were 12 mm wide and placed in the testing machine such that the distance between the clamps was 45 mm. Electrical resistance of electrode material sheets was measured using a custom setup. The sample was attached by silver-plated copper clamps, which served as electrical contacts. The same torque was used when affixing samples in the clamps for consistency. The minimum distance between the clamps/contacts is 30 mm. Resistance was measured using a 4-point probe geometry by Applent AT528 micro-ohmmeter. One of the clamps was stationary, while the second one can be moved by a micrometer screw, thereby stretching the sample. Changes in the sample geometry were tracked and considered for sheet resistance and conductivity calculations.

Measurements of electrical properties of electrode active material powder. The electrode active material powder resistivity measurements were carried out in situ with a customized die set to compress the powders while measuring their resistivity in a 4-point probe geometry. The probe measures the powders under constant pressure with an Applent AT528 micro-ohmmeter. The die set consists of a stainless steel tube with a 5 mm inner diameter insulating ceramic insert tightly fitted within the outer wall. The resistivity was calculated by the equation:

$$ρ = ( A * R ) / L = ( π * ( D / 2 ) \hat{} 2 * R ) / L = ( π D \hat{} 2 R ) / 4 L ,$$

where A is the area, R is the resistance, L is the thickness and D is the diameter of the compressed pellet. The pellet density was calculated by the equation:

$$ρ = Weight / Volume = 4 W / ( π D \hat{} 2 L ) ,$$

where W is the weight, L is the thickness, and D is the diameter of the pellet.

Percolation point. The percolation point is determined by measuring the conductivity of the self-standing electrode while increasing the percentage of mass of the additive (e.g., the conductive material, the electrode active material, or the nanotubes) and retaining the other properties of the self-standing electrode constant. The percolation point is the amount (or percentage) of mass at which the conductivity of the self-standing electrode increases only slow or does not increase with further addition of the additive. The additive is the conductive material, the carbon nanotubes, and/or the electrode active material.

### Example 1: Production of Self-Standing Electrodes (Solution Free Method)

A quartz tube having dimensions of 25 mm OD×22 mm ID×760 mm length was provided as the nanotube synthesis reactor (vessel 210a) for the apparatus 200 (FIG. 5B). The vessel 210a was aligned horizontally with a left end closed with a barrier 502. However, the vessel 210a could be aligned vertically or at any angle therebetween. At the center of barrier 502, a carrier gas inlet 528 was provided for the carrier gas 220a and a catalyst/catalyst precursor inlet 532 was provided for the catalyst/catalyst precursor 130. Both inlets 528 and 532 were positioned to the left of the section of the vessel 210a heated by the heat source 519.

In an illustrative, but non-limiting example, carbon nanotubes can be formed by the following procedure. The vessel 210a is heated to a temperature of about 1300° C. The carrier gas 220a (for example, a mixture of 850 sccm Ar and 300 sccm H₂) is provided to the vessel 210a via the inlet 528. The carbon and catalyst source 530 composition (for example, about 80% ethanol, about 20% methanol, about 0.18% ferrocene, and about 0.375% thiophene) is injected at a rate of about 0.3 ml/min via inlet 532 into the reactor carbon nanotube growth zone, where the ferrocene decomposed to iron catalyst particles and the ethanol was converted to a carbon source for the growth of single-walled nanotubes on the iron catalysts. The ethanol can function as both a solvent for the ferrocene and as the carbon source for growing the nanotubes. The carrier gas 220a then transports the single-walled nanotubes through reactor outlet 575 and into tube 512 as the first aerosolized stream 425a.

Lithium nickel manganese cobalt oxide (LiNiMnCoO₂) particles were used as the electrode active material 506 and were loaded into an aerosolizing chamber (e.g., vessel 210b) on a porous frit (e.g., frit 507) to a height of about 5 mm, loading of about 50 g. The carrier gas 220b, argon (Ar), was provided at a rate of about 2 L/min Ar through frit 507 via inlet 515 (1 L/min; bottom up) and inlets 509, 510 (1 L/min; tangential flows) in combination. Aerosolized suspended LiNiMnCoO₂ exits the aerosolizing chamber (e.g., vessel 210b) as the second aerosolized stream 425b via tube 513 and combines with the first aerosolized stream 425a comprising the synthesized carbon nanotubes via the inlet 518 of the collection vessel 570.

Conductive metal (Cu or Al particles) were used as the conductive metal 508 and were loaded into aerosolizing chamber (e.g., vessel 210c) on frit 557 to a height of about 5 mm. The amount of conductive metal, rate of carrier gas via inlets 558, 559, 560 were chosen to form a self-standing electrode having about 15 wt % conductive material based on the total weight of the nanotubes, electrode active material, and conductive material. The carrier gas 220c, argon, was provided at the desired rate through a porous frit (e.g., frit 557) via inlet 558 (bottom up) and inlets 559, 560 (tangential flows) in combination. Aerosolized suspended conductive material exits aerosolizing chamber (e.g., vessel 210c) as the third aerosolized stream 425c via tube 563 and combines with the first aerosolized stream 425a (comprising the synthesized carbon nanotubes) and the second aerosolized stream 425b (comprising the electrode active material) via the inlet 518 of the collection vessel 570, forming a mixed aerosolized stream 230 of aerosolized, suspended LiNiMnCoO₂, carbon nanotubes, and conductive material in the carrier gases. The mixed aerosolized stream 230 of LiNiMnCoO₂, carbon nanotubes, and conductive material deposits on the substrate 240, in this case a porous frit, as a self-standing electrode 260, as the carrier gases pass through the substrate 240 and out an exhaust 520.

The self-standing electrodes 260 were collected from the substrate 240 and included about 1 wt % single-walled carbon nanotubes, about 15 wt % conductive material, and the balance LiNiMnCoO₂ particles. The self-standing electrode 260 was then treated to increase the density by pressing (about 7 ton), to afford a treated self-standing electrode.

The self-standing electrode 260 (after pressing) is flexible. This may be due to the web-like or non-woven fiber sheet formed by the carbon nanotubes (after pressing). The carbon nanotube web surrounds the LiNiMnCoO₂ particles and metal conductive material to retain the LiNiMnCoO₂ particles and the metal conductive material therein without the need for a binder in a flexible manner that allows for bending of the self-standing electrode.

### Example 2: Production of Self-Standing Electrodes (Wet Methods)

Example 2A. Conductive material in the form of a powder. A suspension of nanotubes, a suspension of electrode active material, and a suspension of conductive material were made. The solvent used to make the individual suspensions was N-methyl-2-pyrrolidone (NMP). To the suspension of nanotubes was added sodium dodecyl sulfate (SDS) at about 5 wt % loading. The suspensions were introduced to element 706 of apparatus 700. The suspended nanotubes, electrode active material, and conductive material were filtered through a porous material 752 by applying a vacuum of about 5 atm (˜0.5 MPa) to the filtrate side 762 of the apparatus 700 to form retentate 730. The retentate 730 was washed with NMP. The self-standing electrode (retentate 730) was collected from the porous material 752 and included about 1 wt % single-walled carbon nanotubes, about 15 wt % conductive material, and the balance LiNiMnCoO₂ particles.

Example 2B. Conductive material in the form of a mesh. In another example, a suspension of electrode active material in NMP was prepared and a suspension of carbon nanotubes in NMP (with 5 wt % SDS) was prepared. The conductive material 707 in the form of a mesh was positioned on the porous material 752 of apparatus 700. The suspensions of nanotubes and electrode active material were introduced to element 706 of apparatus 700. The suspended nanotubes and electrode active material were filtered through the mesh of conductive material and the porous material 752 by applying a vacuum of about 5 atm (˜0.5 MPa) to the filtrate side 762 of the apparatus 700 to form retentate 730. The retentate 730 and the conductive material 707 was washed with NMP. The resulting self-standing electrode (retentate 730 and mesh of conductive material 707 was collected from the porous material 752 and included about 1 wt % single-walled carbon nanotubes, about 15 wt % conductive material, and the balance LiNiMnCoO₂ particles

Aspects described herein include self-standing electrodes and to methods and apparatus for making the same. The self-standing electrodes can be used in batteries such as lithium ion batteries. The self-standing electrodes described herein can have an improved balance of, for example, energy density and electrical conductivity relative to conventional electrodes.

### Aspects Listing

The present disclosure provides, among others, the following aspects, each of which can be considered as optionally including any alternate aspects:
Clause A1. A self-standing electrode, comprising:
nanotubes;
electrode active material; and
conductive material dispersed, embedded, or otherwise incorporated in the nanotubes, the electrode active material, or both.
Clause A2. The self-standing electrode of Clause A1, wherein the conductive material is in the form of mesh, wire, strip, foil, sponge, foam, or combinations thereof.
Clause A3. The self-standing electrode of Clause A1 or Clause A2, wherein the conductive material is in the form of powder, particles, or combinations thereof.
Clause A4. The self-standing electrode of any one of Clauses A1-A3, wherein:
the self-standing electrode is free of a binder material;
the self-standing electrode is free of a separate current conductor layer; or combinations thereof.
Clause A5. The self-standing electrode of any one of Clauses A1-A4, wherein the conductive material comprises copper, aluminum, nickel, platinum, zinc, titanium, stainless steel, sintered carbon, or combinations thereof.
Clause A6. The self-standing electrode of any one of Clauses A1-A5, wherein:
an amount of the nanotubes in the self-standing electrode is from about 0.5 wt % to about 15 wt %, based on a total amount of the nanotubes, the electrode active material, and the conductive material;
an amount of the electrode active material in the self-standing electrode is from about 50 wt % to about 90 wt %, based on the total amount of the nanotubes, the electrode active material, and the conductive material;
an amount of the conductive material in the self-standing electrode is from about 10 wt % to about 40 wt %, based on the total amount of the nanotubes, the electrode active material, and the conductive material; or combinations thereof, the total amount not to exceed 100 wt %.
Clause A7. The self-standing electrode of any one of Clauses A1-A6, wherein:
the nanotubes have a webbed morphology;
the nanotubes comprise single-walled nanotubes, few-walled nanotubes, multi-walled nanotubes, double-walled nanotubes, or combinations thereof; or combinations thereof.
Clause A8. The self-standing electrode of any one of Clauses A1-A7, wherein the nanotubes are carbon nanotubes.
Clause A9. The self-standing electrode of any one of Clauses A1-A8, wherein the electrode active material comprises graphite, hard carbon, silicon, activated carbon, carbon black, or combinations thereof.
Clause A10. The self-standing electrode of any one of Clauses A1-A9, wherein the electrode active material comprises a lithium metal oxide, a lithium metal, a lithium iron phosphate, or combinations thereof.
Clause A11. The self-standing electrode of any one of Clauses A1-A10, wherein the electrode active material comprises LiNiMnCoO₂.
Clause A12. The self-standing electrode of any one of Clauses A1-A11, wherein the self-standing electrode is flexible.
Clause A13. The self-standing electrode of any one of Clauses A1-A12, wherein the self-standing electrode has a density of 1.5 g/cc to 6 g/cc.
Clause A14. The self-standing electrode of any one of Clauses A1-A12, wherein an amount of conductive material in the self-standing electrode is the amount of about the percolation point of the conductive material or exceeding the percolation point of the conductive material.
Clause B1. A battery, comprising:
a self-standing electrode, the self-standing electrode comprising:
   nanotubes;
   electrode active material; and
   conductive material dispersed, embedded, or otherwise incorporated in the nanotubes, the electrode active material, or both.
Clause B2. The battery of Clause B1, wherein the self-standing electrode is free of a binder.
Clause B3. The battery of Clause B1 or Clause B2, further comprising a separator.
Clause B4. The battery of any one of Clauses B1-B3, further comprising an electrolyte.
Clause B5. The battery of any one of Clauses B1-B4, wherein the self-standing electrode is any one of Clauses A1-A13.
Clause C1. An article, comprising: a device; and the battery of any one of Clauses B1-B5, the battery electrically coupled to the device.
Clause C2. The article of Clause C1, wherein the device is a component of a land vehicle, an aircraft, a watercraft, a spacecraft, a satellite, a light emitting diode, a consumer electronic, a wind turbine, a building, a bridge, or a pipeline.
Clause D1. A method of forming a self-standing electrode, the method comprising:
aerosolizing or fluidizing electrode active material and conductive material; and
depositing nanotubes, the aerosolized or fluidized electrode active material, and the aerosolized or fluidized conductive material on a porous substrate to form a self-standing electrode, the self-standing electrode comprising the nanotubes, the electrode active material and the conductive material.
Clause D2. The method of Clause D1, wherein the conductive material of the self-standing electrode is dispersed, embedded, or otherwise incorporated in the nanotubes of the self-standing electrode, the electrode active material of the self-standing electrode, or both.
Clause D3. The method of Clause D1 or Clause D2, wherein:
the self-standing electrode is free of a binder material;
the self-standing electrode is free of a separate current conductor layer; or combinations thereof
Clause D4. The method of any one of Clauses D1-D3, wherein at least two of the nanotubes, the electrode active material, or the conductive material are co-deposited on the porous substrate.
Clause D5. The method of any one of Clauses D1-D4, wherein at least two of the nanotubes, the electrode active material, or the conductive material do not contact until they are deposited on the porous substrate.
Clause D6. The method of any one of Clauses D1-D5, wherein the conductive material that is aerosolized or fluidized is in the form of a powder, a particle, or combinations thereof.
Clause D7. The method of any one of Clauses D1-D6, wherein an amount of conductive material in the self-standing electrode formed is determined by an electrical conductivity percolation point of the conductive material.
Clause D8. The method of any one of Clauses D1-D7, wherein the porous substrate is porous to a gas used for aerosolizing the electrode active material and the conductive material.
Clause D9. The method of any one of Clauses D1-D9, wherein:
the aerosolizing of the electrode active material comprises distributing a first gas through, sequentially, a porous frit and a bed of the electrode active material, in a first chamber to form an aerosolized electrode active material; and
the aerosolizing of the conductive material comprises distributing a second gas through, sequentially, a porous frit and a bed of the conductive material, in a second chamber to form an aerosolized conductive material, the first gas and the second gas being the same or different.
Clause D10. The method of Clause D9, wherein the first gas, the second gas, or both comprises argon gas, helium gas, hydrogen gas, nitrogen gas, or combinations thereof.
Clause D11. The method of any one of Clauses D1-D10, wherein:
the fluidizing of the electrode active material comprises suspending or dispersing the electrode active material in a first liquid medium to form a suspended or dispersed electrode active material; and
the fluidizing of the conductive material comprises suspending or dispersing the conductive material in a second liquid medium to form a suspended or dispersed conductive material.
Clause D12. The method of any one of Clauses D11, wherein the first liquid medium and the second liquid medium, or both comprises a solvent and a surfactant.
Clause D13. The method of any one of Clauses D1-D12, further comprising synthesizing the nanotubes in a nanotube synthesis reactor.
Clause D14. The method of Clause D13, wherein prior to deposition of the nanotubes, the method further comprises carrying the nanotubes from the nanotube synthesis reactor to the porous substrate by a carrier gas.
Clause D15. The method of Clause D14, wherein the carrier gas comprises argon gas, helium gas, hydrogen gas, nitrogen gas, or combinations thereof.
Clause D16. The method of any one of Clauses D1-D15, wherein prior to deposition of the nanotubes, the method further comprises:
suspending or dispersing the nanotubes in a liquid medium to form suspended or dispersed nanotubes; and
directing the suspended or dispersed nanotubes to the porous substrate.
Clause D17. The method of Clause D16, wherein the liquid medium comprises a solvent and a surfactant.
Clause D18. The method of any one of Clauses D1-7, wherein:
the nanotubes comprise single-walled nanotubes, few-walled nanotubes, multi-walled nanotubes, double-walled nanotubes, or combinations thereof;
the conductive material comprises copper, aluminum, nickel, platinum, zinc, titanium, stainless steel, sintered carbon, or combinations thereof; or
combinations thereof.
Clause D19. The method of any one of Clauses D1-D18, wherein:
when the self-standing electrode is an anode, the electrode active material comprises graphite, hard carbon, silicon, activated carbon, carbon black, or combinations thereof; and
when the self-standing electrode is a cathode, the electrode active material comprises a lithium metal oxide, a lithium metal, a lithium iron phosphate, or combinations thereof.
Clause D20. The method of any one of Clauses D1-D19, wherein the electrode active material comprises graphite, hard carbon, silicon, activated carbon, carbon black, or combinations thereof.
Clause D21. The method of any one of Clauses D1-D20, wherein the electrode active material comprises a lithium metal oxide, a lithium metal, a lithium iron phosphate, or combinations thereof.
Clause D22. The method of any one of Clauses D1-D21, wherein the electrode active material comprises LiNiMnCoO₂.
Clause D23. The method of any one of Clauses D1-D22, wherein the nanotubes are carbon nanotubes.
Clause D24. The method of any one of Clauses D1-D23, wherein the porous substrate is positioned in a collection chamber downstream of a nanotube synthesis reactor.
Clause D25. The method of any one of Clauses D1-D24, wherein the porous substrate is positioned in a collection chamber downstream of chambers used for aerosolizing or fluidizing the electrode active material and conductive material.
Clause D26. The method of any one of Clauses D1-D25, wherein the porous substrate is a movable porous substrate.
Clause D27. The method of Clause D26, wherein the movable porous substrate is positioned on a roll-to-roll system.
Clause D28. The method of any one of Clauses D1-D27, wherein an amount of conductive material in the self-standing electrode is the amount of about the percolation point of the conductive material or exceeding the percolation point of the conductive material.
Clause D29. The method of any one of Clauses D1-D28, wherein the self-standing electrode formed is a self-standing electrode described herein.
Clause E1. A method of forming a self-standing electrode, the method comprising:
aerosolizing electrode active material and conductive material;
directing nanotubes, the aerosolized electrode active material, and the aerosolized conductive material to an outlet;
positioning a porous substrate under the outlet; and
depositing nanotubes, the aerosolized electrode active material, and the aerosolized conductive material on a porous substrate to form a self-standing electrode, the self-standing electrode comprising the nanotubes, the electrode active material and the conductive material, the conductive material of the self-standing electrode being dispersed, embedded, or otherwise incorporated in the nanotubes of the self-standing electrode, the electrode active material of the self-standing electrode, or both.
Clause E2. The method of Clause E1, wherein at least two of the nanotubes, the electrode active material or the conductive material are co-deposited on the porous substrate.
Clause E3. The method of Clause E1 or Clause E2, wherein at least two of the nanotubes, the electrode active material or the conductive material do not contact until they are deposited on the porous substrate.
Clause E4. The method of any one of Clauses E1-E3, wherein the conductive material that is aerosolized is in the form of a powder, a particle, or combinations thereof.
Clause E5. The method of any one of Clauses E1-E4, wherein:
the self-standing electrode is free of a binder material;
the self-standing electrode is free of a separate current conductor layer; or
combinations thereof
Clause E6. The method of any one of Clauses E1-E5, wherein an amount of conductive material in the self-standing electrode formed is determined by an electrical conductivity percolation point of the conductive material.
Clause E7. The method of any one of Clauses E1-E6, wherein:
the aerosolizing of the electrode active material comprises distributing a first gas through, sequentially, a porous frit and a bed of the electrode active material, in a first chamber to form an aerosolized electrode active material; and
the aerosolizing of the conductive material comprises distributing a second gas through, sequentially, a porous frit and a bed of the conductive material, in a second chamber to form an aerosolized conductive material, the first gas and the second gas being the same or different.
Clause E8. The method of Clause E7, wherein the porous substrate is porous to the first gas and the second gas.
Clause E9. The method of Clauses E7 or E8, wherein the porous substrate is positioned in a collection chamber downstream of the first chamber and the second chamber.
Clause E10. The method of any one of Clauses E1-E9, wherein:
the nanotubes comprise single-walled nanotubes, few-walled nanotubes, multi-walled nanotubes, double-walled nanotubes, or combinations thereof;
the conductive material comprises copper, aluminum, nickel, platinum, zinc, titanium, stainless steel, sintered carbon, or combinations thereof;
the electrode active material comprises graphite, hard carbon, silicon, activated carbon, carbon black, a lithium metal oxide, a lithium metal, a lithium iron phosphate, or combinations thereof; or
combinations thereof.
Clause E11. The method of any one of Clauses E1-E10, further comprising forming the nanotubes in a nanotubes synthesis reactor.
Clause E12. The method of any one of Clauses E1-E11, wherein an amount of conductive material in the self-standing electrode is the amount of about the percolation point of the conductive material or exceeding the percolation point of the conductive material.
Clause E13. The method of any one of Clauses E1-E12, wherein the self-standing electrode formed is a self-standing electrode described herein.
Clause E14. The method of any one of Clauses E1-E13, wherein the porous substrate is a movable porous substrate.
Clause F1. A method of forming a self-standing electrode, the method comprising:
introducing at least one suspension or dispersion to a pressure-controlled system, the pressure-controlled system comprising a container and an element having a substrate (or porous material) disposed therein, the substrate (or porous material) disposed above the container, wherein:
   each suspension or dispersion of the at least one suspension or dispersion comprises one or more of nanotubes, electrode active material, or conductive material; and
   the conductive material of the at least one suspension or dispersion is in the form of, or derived from, a powder, a particle, or combinations thereof; and
applying a pressure differential across the substrate (or porous material) to draw the at least one suspension or dispersion from the element, through the substrate (or porous material), and to the container to form a filtrate disposed within the container and a retentate disposed above the substrate (or porous material), the retentate comprising the self-standing electrode, the self-standing electrode comprising the nanotubes, the electrode active material, and the conductive material.
Clause F2. The method of Clause F1, wherein the conductive material of the self-standing electrode is dispersed, embedded, or otherwise incorporated in the nanotubes of the self-standing electrode, the electrode active material of the self-standing electrode, or both.
Clause F3. The method of Clause F1 or Clause F2, wherein an amount of conductive material in the self-standing electrode formed is determined by an electrical conductivity percolation point of the conductive material.
Clause F4. The method of any one of Clauses F1-F3, wherein the substrate (or porous material) is configured to be:
porous to a liquid medium of the at least one suspension or dispersion; and
substantially impervious or impervious to the formed self-standing electrode.
Clause F5. The method of any one of Clauses F1-F4, wherein the at least one suspension or dispersion further comprises a solvent and a surfactant.
Clause F6. The method of any one of Clauses F1-F5, wherein a first suspension or dispersion of the at least one suspension or dispersion comprises at least two different suspensions or dispersions comprising at least one of the nanotubes, the electrode active material, or the conductive material.
Clause F7. The method of any one of Clauses F1-F6, wherein the nanotubes comprise single-walled nanotubes, few-walled nanotubes, multi-walled nanotubes, double-walled nanotubes, or combinations thereof.
Clause F8. The method of any one of Clauses F1-F7, wherein the conductive material comprises copper, aluminum, nickel, platinum, zinc, titanium, stainless steel, sintered carbon, or combinations thereof.
Clause F9. The method of any one of Clauses F1-F8, wherein the electrode active material comprises graphite, hard carbon, silicon, activated carbon, carbon black, or combinations thereof.
Clause F10. The method of any one of Clauses F1-F9, wherein the electrode active material comprises a lithium metal oxide, a lithium metal, a lithium iron phosphate, or combinations thereof.
Clause F11. The method of any one of Clauses F1-F10, wherein the substrate (or porous material) is a movable substrate (or movable porous material).
Clause F12. The method of Clause F11, wherein the movable substrate (or movable porous material) is positioned on a roll-to-roll system.
Clause F13. The method of any one of Clauses F1-F12, wherein an amount of conductive material in the self-standing electrode is the amount of about the percolation point of the conductive material or exceeding the percolation point of the conductive material.
Clause F14. The method of any one of Clauses F1-F13, wherein:
the self-standing electrode is free of a binder material;
the self-standing electrode is free of a separate current conductor layer; or
combinations thereof.
Clause F14. The method of any one of Clauses F1-F13, wherein the self-standing electrode formed is a self-standing electrode described herein.
Clause G1. A method of forming a self-standing electrode, the method comprising:
introducing one or more suspensions or dispersions to a pressure-controlled system, each of the one or more suspensions or dispersions comprising at least one of nanotubes or electrode active material, the pressure-controlled system comprising:
   a container;
   an element having a substrate (or porous material) disposed therein, the substrate (or porous material) disposed above the container; and
   a conductive material disposed above the substrate (or porous material); and
applying a pressure differential across the substrate (or porous material) to draw the suspension or dispersion from the element, through the substrate (or porous material), and to the container to form a filtrate disposed within the container and a retentate disposed above the substrate (or porous material), the retentate comprising the self-standing electrode, the self-standing electrode comprising the nanotubes, the electrode active material, and the conductive material.
Clause G2. The method of Clause G1, wherein the one or more suspensions or dispersions is free of the conductive material of the self-standing electrode.
Clause G3. The method of Clause G1 or Clause G2, wherein the conductive material is in the form of a mesh, wire, strip, foil, sponge, foam, or combinations thereof.
Clause G4. The method of any one of Clauses G1-G3, wherein the self-standing electrode is free of a binder material.
Clause G5. The method of any one of Clauses G1-G4, wherein an amount of conductive material in the self-standing electrode formed is determined by an electrical conductivity percolation point of the conductive material.
Clause G6. The method of any one of Clauses G1-G5, wherein the substrate (or porous material) is configured to be:
porous to a liquid medium of the one or more suspensions or dispersions; and
substantially impervious or impervious to the self-standing electrode formed.
Clause G7. The method of any one of Clauses G1-G6, wherein the one or more suspensions or dispersions further comprises a solvent and a surfactant.
Clause G8. The method of any one of Clauses G1-G7, wherein:
a first suspension or dispersion of the one or more suspensions or dispersions comprises the nanotubes; and
a second suspension or dispersion of the one or more suspensions or dispersions comprises the electrode active material.
Clause G9. The method of any one of Clauses G1-G8, wherein:
the nanotubes comprise single-walled nanotubes, few-walled nanotubes, multi-walled nanotubes, double-walled nanotubes, or combinations thereof;
the conductive material comprises copper, aluminum, nickel, platinum, zinc, titanium, stainless steel, sintered carbon, or combinations thereof; or
combinations thereof.
Clause G10. The method of any one of Clauses G1-G9, wherein the electrode active material comprises graphite, hard carbon, silicon, activated carbon, carbon black, or combinations thereof.
Clause G11. The method of any one of Clauses G1-G10, wherein the electrode active material comprises a lithium metal oxide, a lithium metal, a lithium iron phosphate, or combinations thereof.
Clause G12. The method of any one of Clauses G1-G11, wherein the nanotubes are carbon nanotubes.
Clause G13. The method of any one of Clauses G1-G12, wherein the substrate (or porous material) is a movable substrate (or movable porous substrate).
Clause G14. The method of Clause G13, wherein the movable substrate (or movable porous substrate) is positioned on a roll-to-roll system.
Clause G15. The method of any one of Clauses G1-G14, wherein an amount of conductive material in the self-standing electrode is the amount of about the percolation point of the conductive material or exceeding the percolation point of the conductive material.
Clause G16. The method of any one of Clauses G1-G15, wherein the self-standing electrode formed is a self-standing electrode described herein.
Clause H1. An apparatus for forming a self-standing electrode, the apparatus comprising:
a nanotube synthesis reactor for forming nanotubes;
a first aerosolizing chamber configured to aerosolize an electrode active material into an aerosolized electrode active material;
a second aerosolizing chamber configured to aerosolize a conductive material into an aerosolized conductive material; and
a collection chamber fluidly coupled to the nanotube synthesis reactor, the first aerosolizing chamber, and the second aerosolizing chamber, wherein:
   the collection chamber has a surface configured to collect the nanotubes, the electrode active material, and the conductive material; and
   the collection chamber is further configured to remove aerosolizing gas so as to form the self-standing electrode comprising the nanotubes, the electrode active material, and the conductive material.
Clause H2. The apparatus of Clause H1, further comprising a carrier gas fluidly coupled to the nanotube synthesis reactor, the carrier gas configured to carry the nanotubes to the collection chamber.
Clause H3. The apparatus of Clause H1 or Clause H2, wherein the first aerosolizing chamber, the second aerosolizing chamber, or both comprise a vertical shaker, one or more gas inlets, one or more outlets, and a porous frit.
Clause H4. The apparatus of any one of Clauses H1-H3, wherein:
at least two of the first aerosolizing chamber, the second aerosolizing chamber, or nanotube synthesis reactor are parallel to each other; and
each of the first aerosolizing chamber, the second aerosolizing chamber, and nanotube synthesis reactor are upstream of the collection chamber.
Clause H5. The apparatus of any one of Clauses H1-H4, wherein: the apparatus is used to form a self-standing electrode described herein; the apparatus is used with a method described herein; or combinations thereof.
Clause I1. An apparatus for forming a self-standing electrode, the apparatus comprising:
a porous material (or porous substrate) defining a retentate side and a filtrate side, the porous material (or porous substrate) being porous to a liquid medium, the porous material (or porous substrate) being substantially impervious or impervious to a composite of nanotubes, an electrode active material, and a conductive material;
a container on the filtrate side of the porous material (or porous substrate);
a pressure source coupled to the container; and
an element coupled to the container, at least a portion of the element on the filtrate side of the porous material (or porous substrate).
Clause I2. The apparatus of Clause I1, wherein the porous material (or porous substrate) is disposed within the element and across a diameter of the element.
Clause I3. The apparatus of Clause I1 or Clause I2, wherein the porous material (or porous substrate) is positioned on a roll-to-roll system.
Clause I4. The apparatus of any one of Clauses I1-13, wherein:
the conductive material is positioned above the porous material (or porous substrate);
the conductive material is in the form of a mesh, wire, strip, foil, sponge, foam, or combinations thereof; or
combinations thereof.
Clause I5. The apparatus of any one of Clauses I1-I4, wherein: the apparatus is used to form a self-standing electrode described herein; the apparatus is used with a method described herein; or combinations thereof.

As is apparent from the foregoing general description and the specific aspects, while forms of the aspects have been illustrated and described, various modifications can be made without departing from the spirit and scope of the present disclosure. Accordingly, it is not intended that the present disclosure be limited thereby. Likewise, the term “comprising” is considered synonymous with the term “including.” Likewise whenever a composition, an element or a group of elements is preceded with the transitional phrase “comprising,” it is understood that we also contemplate the same composition or group of elements with transitional phrases “consisting essentially of,” “consisting of,” “selected from the group of consisting of,” or “Is” preceding the recitation of the composition, element, or elements and vice versa, e.g., the terms “comprising,” “consisting essentially of,” “consisting of” also include the product of the combinations of elements listed after the term.

For purposes of this present disclosure, and unless otherwise specified, all numerical values within the detailed description and the claims herein are modified by “about” or “approximately” the indicated value, and consider experimental error and variations that would be expected by a person having ordinary skill in the art. For the sake of brevity, only certain ranges are explicitly disclosed herein. However, ranges from any lower limit may be combined with any upper limit to recite a range not explicitly recited, as well as, ranges from any lower limit may be combined with any other lower limit to recite a range not explicitly recited, in the same way, ranges from any upper limit may be combined with any other upper limit to recite a range not explicitly recited. Additionally, within a range includes every point or individual value between its end points even though not explicitly recited. Thus, every point or individual value may serve as its own lower or upper limit combined with any other point or individual value or any other lower or upper limit, to recite a range not explicitly recited.

As used herein, the indefinite article “a” or “an” shall mean “at least one” unless specified to the contrary or the context clearly indicates otherwise. For example, aspects comprising “a nanotube” include aspects comprising one, two, or more nanotubes, unless specified to the contrary or the context clearly indicates only one nanotube is included. As another example, aspects comprising “a particle” include aspects comprising one, two, or more particles, unless specified to the contrary or the context clearly indicates only one particle is included.

While the foregoing is directed to aspects of the present disclosure, other and further aspects of the disclosure may be devised without departing from the basic scope thereof, and the scope thereof is determined by the claims that follow.

What is claimed is:

1. A method of forming a self-standing electrode, the method comprising:
aerosolizing electrode active material and conductive material;
directing nanotubes, the aerosolized electrode active material, and the aerosolized conductive material to an outlet;
positioning a porous substrate under the outlet;
depositing nanotubes, the aerosolized electrode active material, and the aerosolized conductive material on a porous substrate to form a self-standing electrode, the self-standing electrode comprising the nanotubes, the electrode active material and the conductive material, the conductive material of the self-standing electrode being dispersed, embedded, or otherwise incorporated in the nanotubes of the self-standing electrode, the electrode active material of the self-standing electrode, or both; and
removing the self-standing electrode from the porous substrate.

2. The method of claim 1, wherein an amount of conductive material in the self-standing electrode formed is determined by an electrical conductivity percolation point of the conductive material.

3. The method of claim 1, wherein at least two of the nanotubes, the electrode active material, or the conductive material do not contact until they are deposited on the porous substrate.

4. The method of claim 1, wherein:
the aerosolizing of the electrode active material comprises distributing a first gas through, sequentially, a porous frit and a bed of the electrode active material, in a first chamber to form an aerosolized electrode active material;
the aerosolizing of the conductive material comprises distributing a second gas through, sequentially, a porous frit and a bed of the conductive material, in a second chamber to form an aerosolized conductive material, the first gas and the second gas being the same or different.

5. The method of claim 1, further comprising forming the nanotubes in a nanotubes synthesis reactor.

6. The method of claim 1, wherein the conductive material that is aerosolized is in the form of a powder, a particle, or combinations thereof.

7. The method of claim 1, wherein the self-standing electrode is free of a binder.

8. An apparatus for forming a self-standing electrode, the apparatus comprising:
a nanotube synthesis reactor for forming nanotubes;
a first aerosolizing chamber configured to aerosolize an electrode active material into an aerosolized electrode active material;
a second aerosolizing chamber configured to aerosolize a conductive material into an aerosolized conductive material; and
a collection chamber fluidly coupled to the nanotube synthesis reactor, the first aerosolizing chamber, and the second aerosolizing chamber, wherein:
the collection chamber has a surface configured to collect the nanotubes, the electrode active material, and the conductive material; and
the collection chamber is further configured to remove aerosolizing gas so as to form the self-standing electrode comprising the nanotubes, the electrode active material, and the conductive material.

9. The apparatus of claim 8, further comprising a carrier gas fluidly coupled to the nanotube synthesis reactor, the carrier gas configured to carry the nanotubes to the collection chamber.

10. The apparatus of claim 8, wherein the first aerosolizing chamber, the second aerosolizing chamber, or both comprise a vertical shaker, one or more gas inlets, one or more outlets, and a porous frit.

11. The apparatus of claim 8, wherein:
at least two of the first aerosolizing chamber, the second aerosolizing chamber, or nanotube synthesis reactor are parallel to each other; and
each of the first aerosolizing chamber, the second aerosolizing chamber, and nanotube synthesis reactor are upstream of the collection chamber.

12. A self-standing electrode, comprising:
nanotubes;
electrode active material; and
conductive material dispersed, embedded, or otherwise incorporated in the nanotubes, the electrode active material, or both, the self-standing electrode free of a binder material.

13. The self-standing electrode of claim 12, wherein the conductive material is in the form of mesh, wire, strip, foil, sponge, foam, or combinations thereof.

14. The self-standing electrode of claim 12, wherein the conductive material is in the form of powder, particles, or combinations thereof.

15. The self-standing electrode of claim 12, wherein the self-standing electrode is free of separate current conductor layer.

16. The self-standing electrode of claim 12, wherein:
the conductive material comprises copper, aluminum, nickel, platinum, zinc, titanium, stainless steel, sintered carbon, or combinations thereof; and
an amount of conductive material in the self-standing electrode is the amount of about the percolation point of the conductive material or exceeding the percolation point of the conductive material.

17. The self-standing electrode of claim 12, wherein:
an amount of the nanotubes in the self-standing electrode is from about 0.5 wt % to about 15 wt %, based on a total amount of the nanotubes, the electrode active material, and the conductive material;
an amount of the electrode active material in the self-standing electrode is from about 50 wt % to about 90 wt %, based on the total amount of the nanotubes, the electrode active material, and the conductive material;
an amount of the conductive material in the self-standing electrode is from about 10 wt % to about 50 wt %, based on the total amount of the nanotubes, the electrode active material, and the conductive material; or
combinations thereof, the total amount not to exceed 100 wt %.

18. The self-standing electrode of claim 12, wherein:
the nanotubes have a webbed morphology;
the nanotubes comprise single-walled nanotubes, few-walled nanotubes, multi-walled nanotubes, double-walled nanotubes, or combinations thereof; or
combinations thereof.

19. A battery, comprising:
the self-standing electrode of claim 12.

20. An article, comprising:
a device; and
a battery electrically coupled to the device, the battery comprising the self-standing electrode of claim 12.
